(19) United States
(12) Patent Application Publication
(10) Pub. No.: US 2008/0229203 A1
(43) Pub. Date: Sep. 18, 2008

(54) Method of identifying video assets

(76) Inventor: Michael L. Woodley, Cambridge (GB)

Correspondence Address: JAMES C. WRAY, 1493 CHAIN BRIDGE ROAD, SUITE 300, MCLEAN, VA, 22101, US

(21) Appl. No.: 12/075,786

(22) Filed: Mar. 13, 2008

(30) Foreign Application Priority Data
Mar. 13, 2007 (GB) 07 04 761.6

(51) Int. Cl. G06F 3/048; G06F 7/06; G06F 17/30

(52) U.S. Cl. 715/719; 707/6; 707/E17.017

(57) ABSTRACT

A method of identifying video assets with reference to spoken audio content is provided. The method comprises the steps of receiving a text string to define the audio content of interest; searching a database to identify instances of the received text string; and displaying an image taken from the respective video asset which contains each of the instances.

### CROSS REFERENCE TO RELATED APPLICATIONS

This application claims priority from United Kingdom Patent Application No. 07 04 761.6, filed 13 Mar. 2007, the entire disclosure of which is incorporated herein by reference in its entirety.

### TECHNICAL FIELD

The present invention relates to a method of identifying video assets with reference to spoken audio content.

### BACKGROUND OF THE INVENTION

A number of environments exist in which it is desirable to have the capability of identifying video assets with reference to spoken audio content. Video assets can comprise films, television programmes, any other video footage or computer graphics or any other content with an audio component that is spoken. Environments in which it is desirable to identify assets with reference to spoken audio content include research, entertainment and archiving. Many further applications of the technique are also possible. Searching through an asset manually to identify spoken audio content of interest is a lengthy and tedious task.

### BRIEF SUMMARY OF THE INVENTION

According to a first aspect of the present invention, there is provided a method of identifying video assets with reference to spoken audio content. The method comprises the steps of: receiving a text string to define the audio content of interest; searching a database to identify instances of the received text string; and displaying an image taken from the respective video asset which contains each of the instances.

According to a second aspect of the present invention, there is provided a computer-readable medium having computer-readable instructions executable by a computer such that, when executing said instructions, a computer will perform the steps of: receiving a text string to define audio content of interest; searching a database to identify instances of said received text string; and displaying an image taken from the respective video asset which contains each of said instances.

### BRIEF DESCRIPTION OF THE SEVERAL VIEWS OF THE DRAWINGS

FIG. 1 shows an example of an environment in which an embodiment of the invention may be used;

FIG. 2 illustrates details of an example of a processing system 200;

FIG. 3 illustrates operation of a station such as that illustrated in FIG. 1;

FIG. 4 shows an example of a main menu;

FIG. 5 expands on step 305;

FIG. 6 shows an example of steps 501 and 502;

FIG. 7 shows an example of the display when the database is being queried;

FIG. 8 shows an expansion of step 503;

FIG. 9 shows an example of tables within the database;

FIG. 10 expands on step 804;

FIG. 11 shows an example of table 902;

FIG. 12 shows the procedure for conversion of time in seconds;

FIG. 13 shows the calculation for conversion of time into seconds;

FIG. 14 shows a diagrammatic representation of a timeline;

FIG. 15 illustrates the display of results;

FIG. 16 shows an example of a search screen;

FIG. 17 shows an option screen for an advanced search;

FIG. 18 shows the screen of FIG. 17 after user input has been received;

FIG. 19 shows an expansion of step 802;

FIG. 20 illustrates a display shown while the database is being searched;

FIG. 21 shows an expansion of step 506;

FIG. 22 illustrates a display of a result list;

FIG. 23 illustrates an image displayed indicating that a clip is being retrieved;

FIG. 24 illustrates the selection of a portion of an asset to be displayed as a clip;

FIG. 25 shows the display of a clip;

FIG. 26 illustrates an expansion of step 307;

FIG. 27 shows a trivia menu;

FIG. 28 shows a similar view to FIG. 27 with the addition of user input received;

FIG. 29 shows an example of a search screen within the trivia operation;

FIG. 30 shows an image displayed whilst the search is taking place;

FIG. 31 expands on step 2607;

FIG. 32 shows an example of a question;

FIG. 33 shows an example of a failure screen;

FIG. 34 shows a second example of a question;

FIG. 35 shows an example of a success screen;

FIG. 36 expands on step 309;

FIG. 37 shows an example of a “What's new?” screen;

FIG. 38 shows a search screen within the what's new function;

FIG. 39 illustrates an image displayed while the search is taking place;

FIG. 40 shows the results list;

FIG. 41 shows an image displayed whilst the clip is being retrieved; and

FIG. 42 illustrates the display of a clip.

### DESCRIPTION OF THE BEST MODE FOR CARRYING OUT THE INVENTION

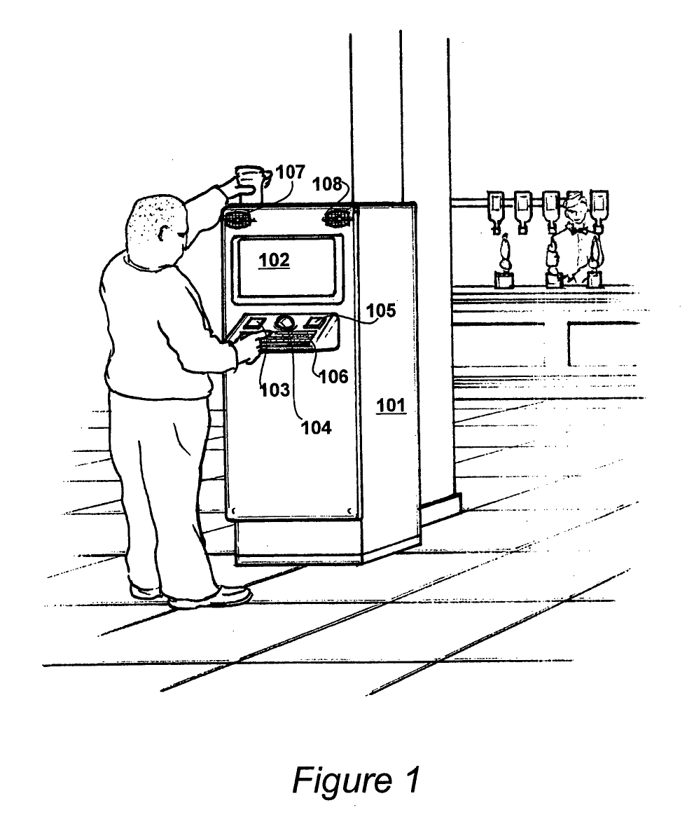

### FIG. 1

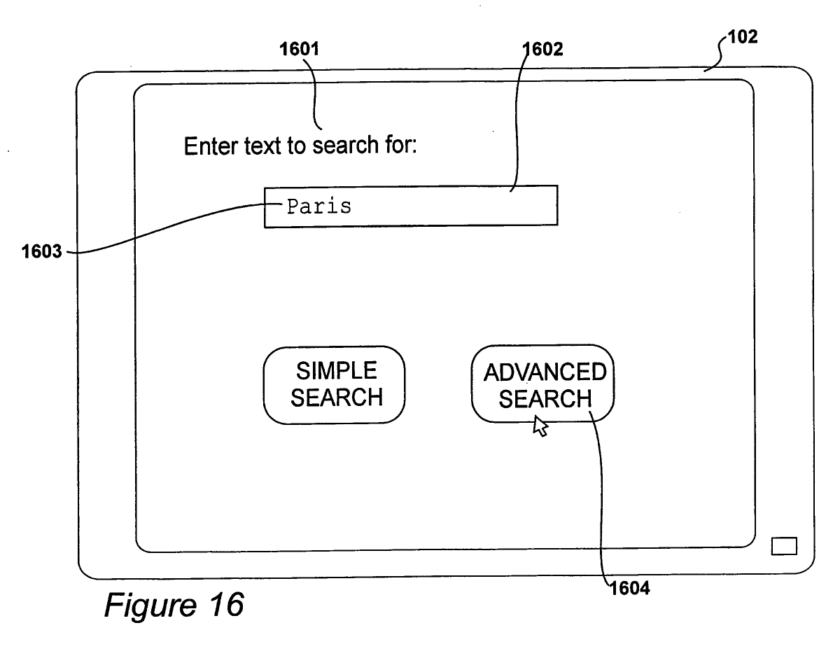

An example of an environment in which an embodiment of the invention may be used is illustrated in FIG. 1. Given the facility to search video assets with reference to spoken audio content an interactive search and trivia station can be provided. The station 101 is shown in this embodiment as a stand-alone facility, such that data is loaded onto it at set up, and later updates may be available but a connection to a network such as the Internet is not provided. An alternative embodiment in which a connection to a network such as the Internet is provided is described with reference to FIGS. 16 to 25. Station 101 has display means 102 and various input means such as buttons 103 and 104, roller wheel 105 and keyboard 106. Images and text prompting user input are displayed on display means 102, and user input is received by input devices 103 to 106. In alternative embodiments further input devices such as a mouse, joystick or other facilities are provided. Speakers 107 and 108 are provided to play audio content and, if appropriately configured, to prompt a user for input.

FIG. 1 illustrates station 101 in use in a social environment such as a public house, shop—(particularly a shop which provides for the rental or purchase of films) or entertainment arcade. The station could also be positioned in any location as desired.

As well as the entertainment applications of the embodiment, the facility to search assets based on their audio content may have many and varied research applications.

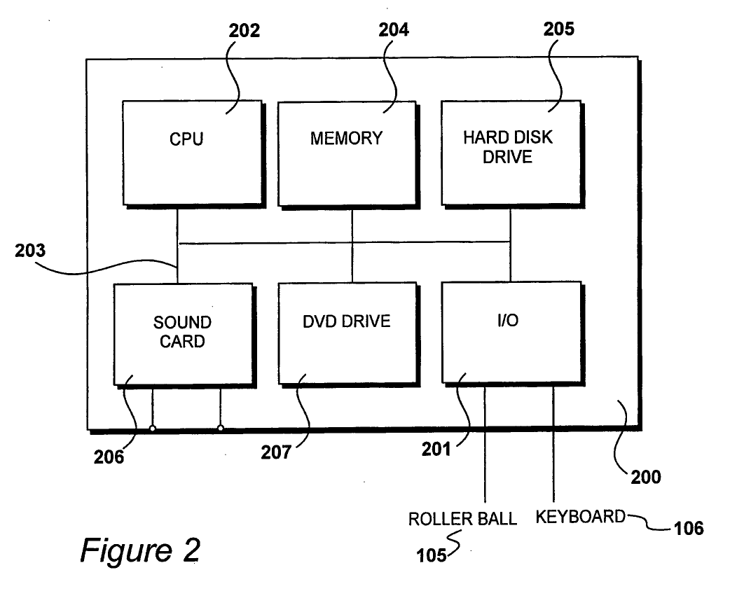

### FIG. 2

Details of an example of a processing system 200 contained within station 101 are shown in FIG. 2. Keyboard 106 and roller ball 105 communicate with a serial bus interface 201. A Central Processing Unit (CPU) 202 fetches and executes instructions and manipulates data. CPU 202 is connected to system bus 203. Memory is provided at 204. A hard disk drive 205 provides non-volatile bulk storage of instructions and data. Memory 204 and hard disk drive 205 are also connected to system bus 203. A sound card 206 receives sound information from CPU 202 via system bus 203. A DVD drive 207 is provided, primarily for initial set up but also for periodic updates of data and executable instructions. Data and instructions from DVD drive 207 and input/output bus 201 are transmitted to CPU 202 via system bus 203.

While the system illustrated in FIG. 2 is an example of components that are used to implement an embodiment of the invention, it should be appreciated that any standard personal computer could be used.

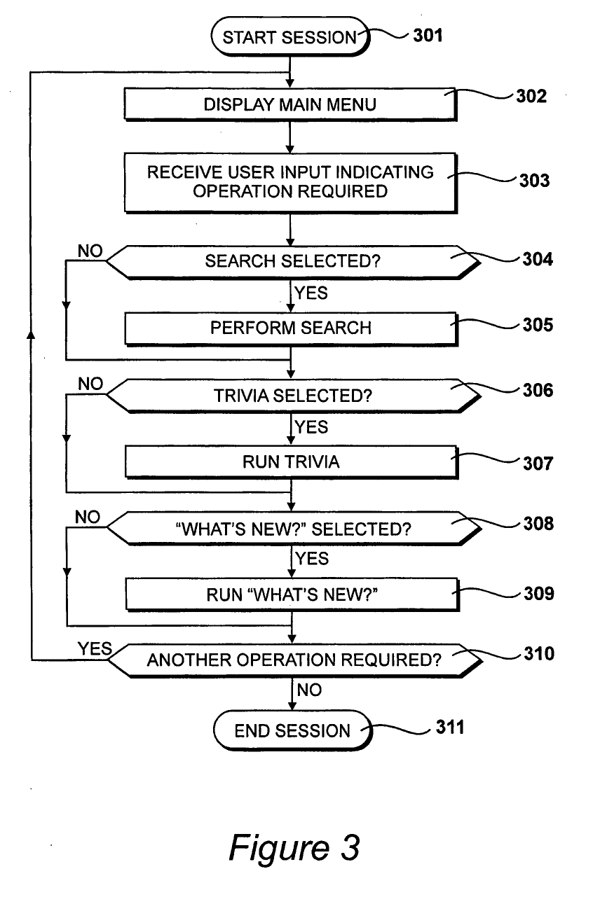

### FIG. 3

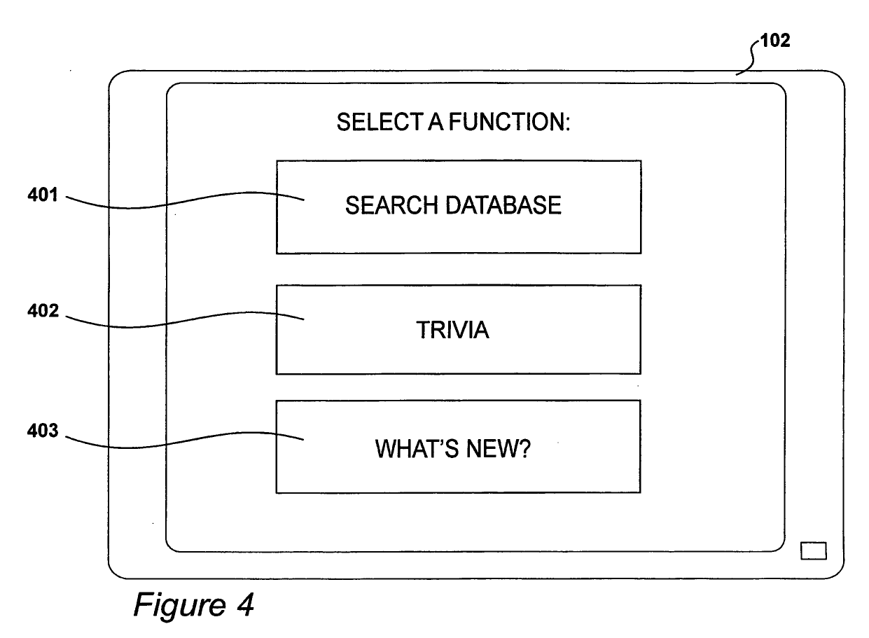

Operation of a station such as that illustrated in FIG. 1 is described with reference to the flow chart in FIG. 3. The session starts at step 301, and at step 302 the main menu is displayed. This is shown in FIG. 4. The display of main menu on display means 102 presents options to a user and at step 303 user input is received indicating which operation is required. This input may be received via any of input devices 103 to 106, or by whatever other input means may be provided.

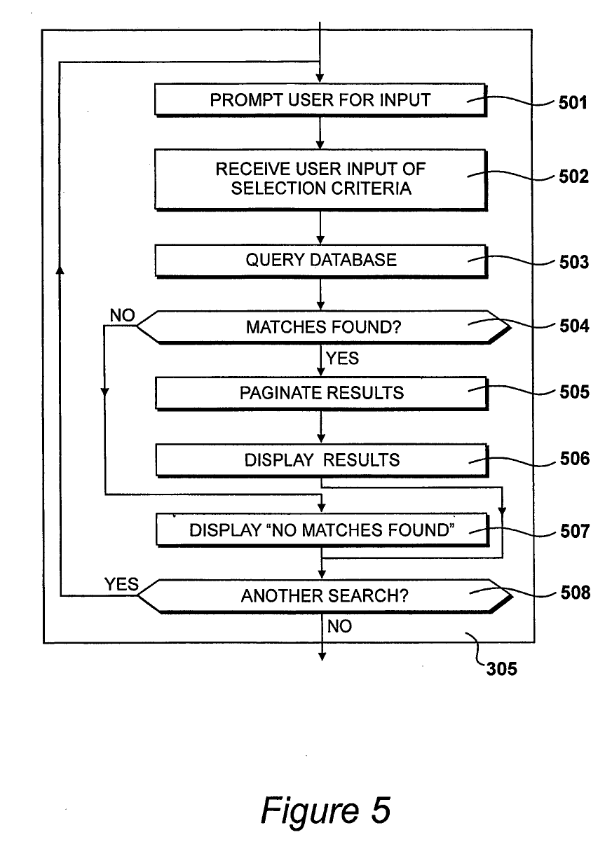

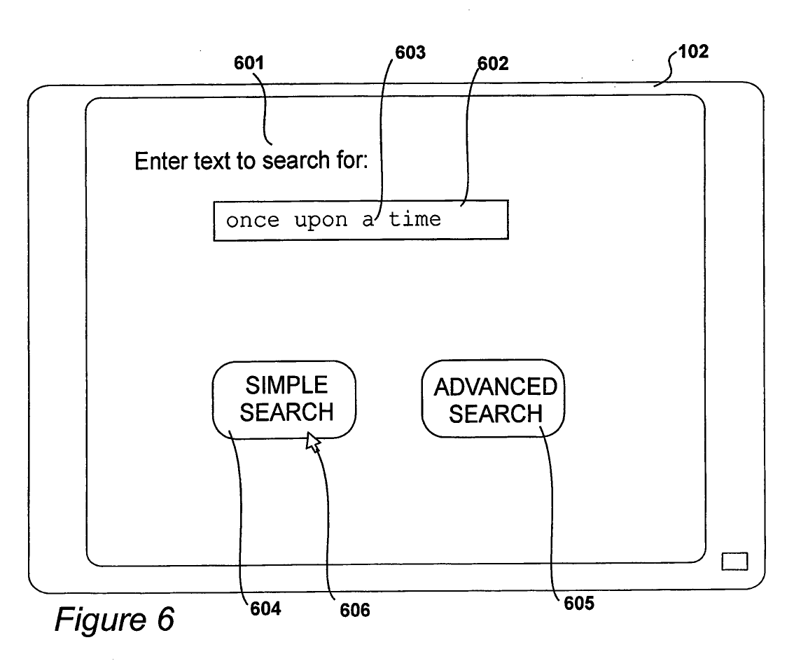

At step 304 a question is asked as to whether a search has been selected and if this question is answered in the affirmative then a search is performed at step 305. Step 305 is further expanded in FIG. 5, a simple search is further described with reference to FIGS. 6 to 15, and an advanced search is further described with reference to FIGS. 16 to 25. If the question asked at step 304 is answered in the negative, then step 305 is omitted.

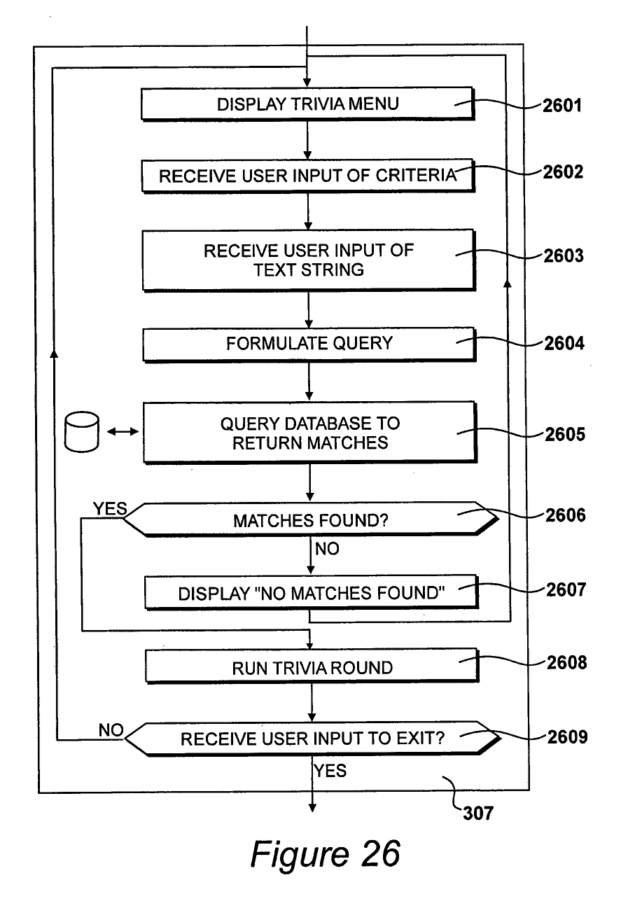

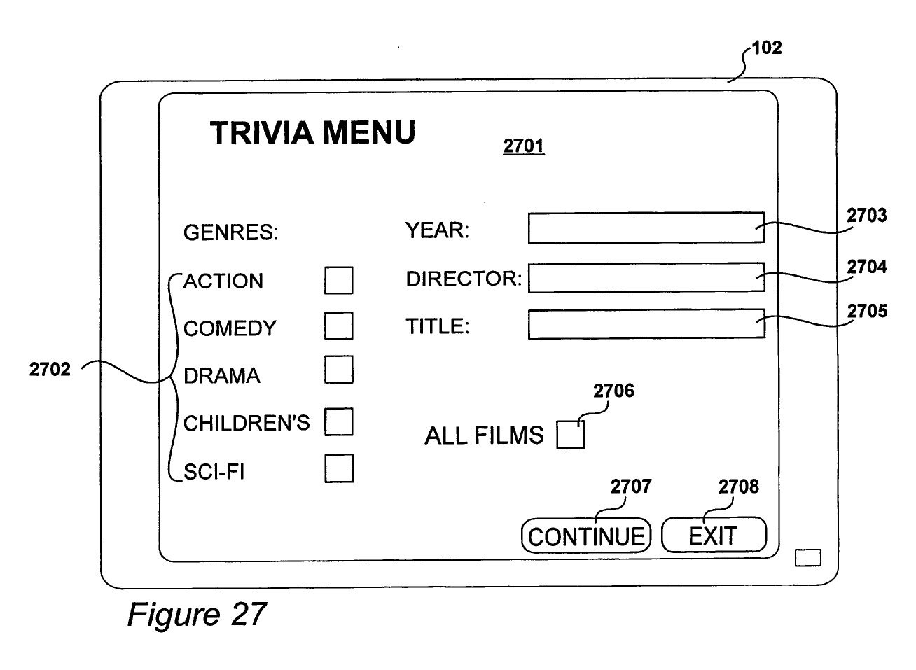

At step 306 a question is asked as to whether the trivia operation has been selected. If this question is answered in the affirmative then the trivia operation is executed at step 307. This step is further expanded in FIG. 26 and further described with reference to FIGS. 27 to 35. If the question asked at step 306 is answered in the negative, such that trivia has not been selected within step 307 is omitted.

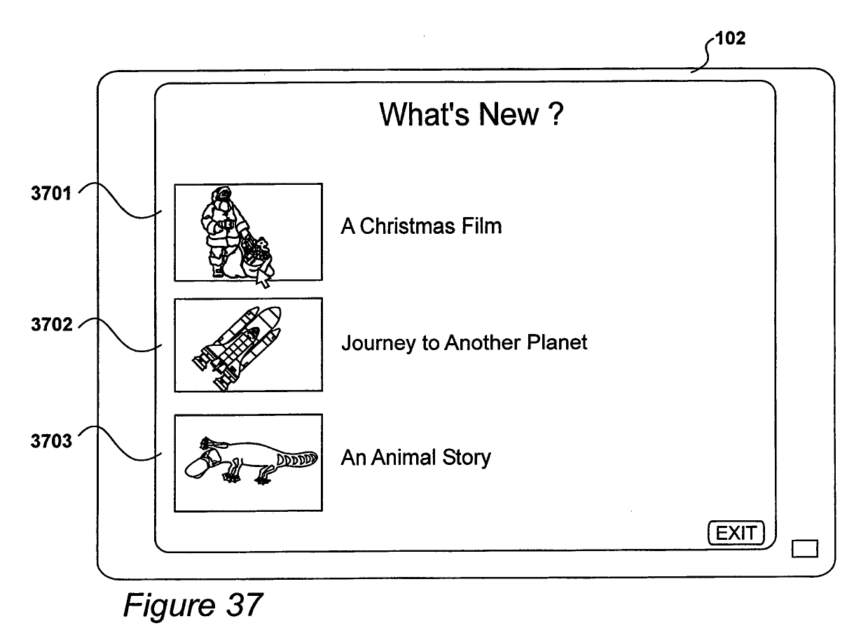

At step 308 a question is asked as to whether “What's new?” has been selected. If this question is answered in the affirmative then the whether “What's new?” operation is executed at step 309. Step 309 is further expanded and the operation of “What's new?” is further described with reference to FIGS. 37 to 42. If the question asked at step 308 is answered in the negative then step 309 is omitted.

At step 310 a question is asked as to whether another operation is required. Once any of the options has been completed, or aborted the main menu is again displayed if the user requires further operations. Thus control passes back to step 302. If the user does not require further operations then the session ends at 311.

The three operations (search, trivia and “What's new?”) that are described serve merely as examples of facilities available. Depending upon configuration of the station 101 further or different operations can be executed. FIG. 3 illustrates the top level of operation within station 101. Many of the steps shown in FIG. 3 are further expanded in later Figures.

### FIG. 4

An example of a main menu that is displayed on display means 102 at step 302 is shown in FIG. 4. In this embodiment, three options are provided for the user to make a selection from. Depending upon the configuration of station 101, input may be received via keyboard 106, buttons 103 and 104 or roller ball 105. Input is received selecting either option 401 to search the database, option 402 to run the trivia or option 403 to use the “What's new?” facility. The procedure when option 401 to search the database is selected will now be further described with reference to FIG. 5.

### FIG. 5

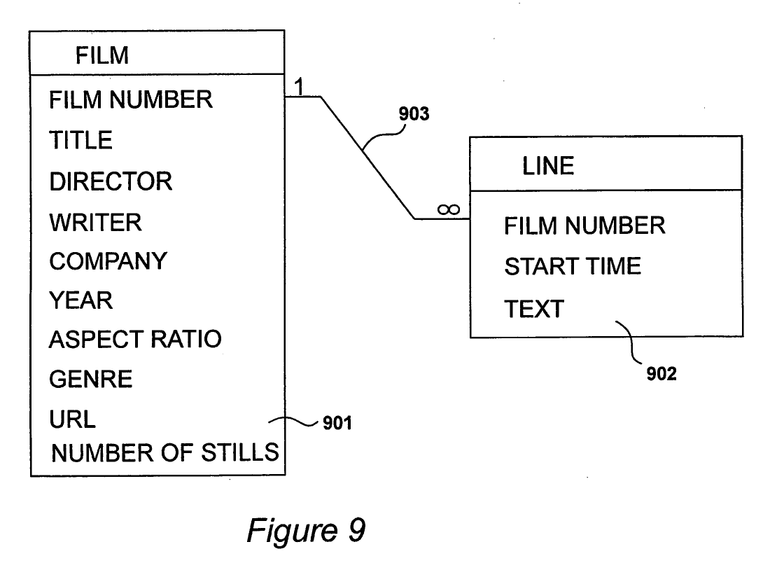

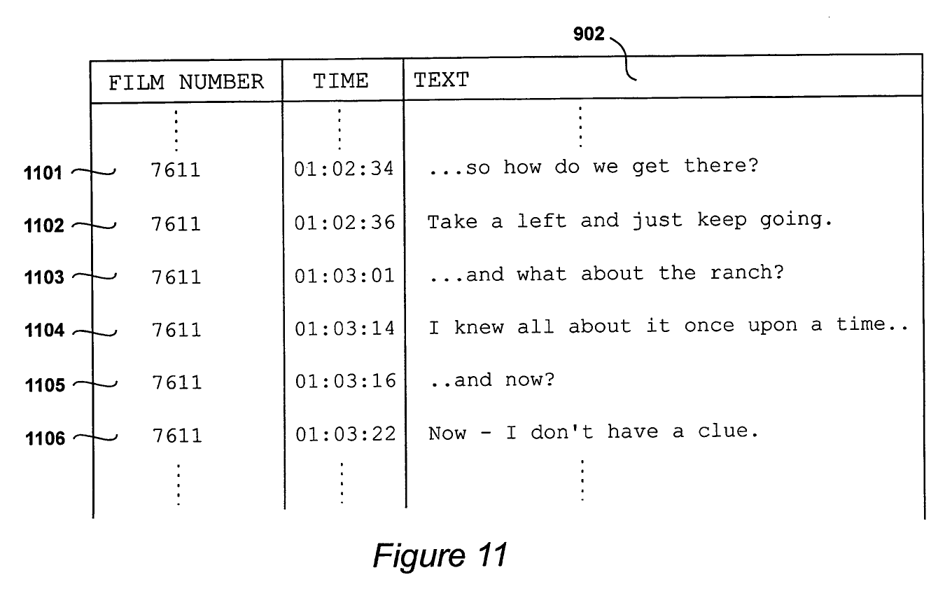

Step 305 shown in FIG. 3 that executes when option 401 from FIG. 4 is selected is further illustrated in FIG. 5. At step 501 the user is prompted for input. An example of this is shown in FIG. 6, whereby the prompt takes the form of a graphical display on display means 102, but alternatively the prompt could occur by other means such as an audio prompt played through speakers 107 and 108, or another form of prompt. As a result of this prompt at step 501, user input is received identifying selection criteria at step 502. This is also illustrated in FIG. 6. At step 503, the database is queried. In this embodiment, the database is preloaded onto station 101. An example of the content of this database is described with reference to FIGS. 9 and 11.

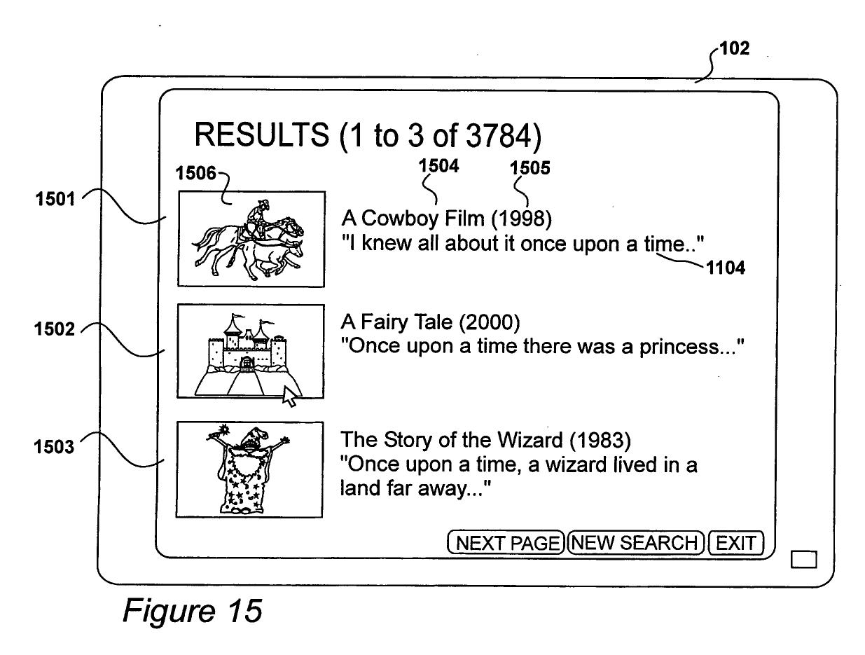

Once the query has taken place at step 503, a question is asked at step 504 as to whether any matches have been found. If this question is answered in the affirmative then the results are paginated at step 505, and displayed at step 506. In contrast, if the question asked at step 504 is answered in the negative then steps 505 and 506 are omitted and a message indicating that no matches have been found is displayed at step 507. An example of results displayed at step 506 is shown in FIG. 15.

After the display of either results at step 506 or a message indicating that no matches have been found at step 507, either being displayed on display means 102, a question is asked at step 508 as to whether another search is required. If this question is answered in the affirmative then the procedure repeats from step 501. If this question is answered in the negative then the perform search operation is complete.

### FIG. 6

Steps 501 and 502 described with reference to FIG. 5 are exemplified in FIG. 6. A prompt message 601 is displayed above a text field 602 on display means 102. Whilst in this example the prompt is graphical it could also be audio or some other format. The receipt at step 502 of user input of selection criteria takes the form, initially, of a text string typed into field 602 via keyboard 106. In this case, text string 603 is the words “once upon a time”. In the present embodiment, two searching options are provided. A first option, a simple search, is provided by selection of button 604. A second option, an advanced search, is provided by selection of button 605. In this embodiment, cursor 606 is provided to allow selection of options by movement of, for example, roller ball 105. In alternative embodiments different selection means, such as a touch screen, joystick, or allocated buttons on the station 101 could be provided.

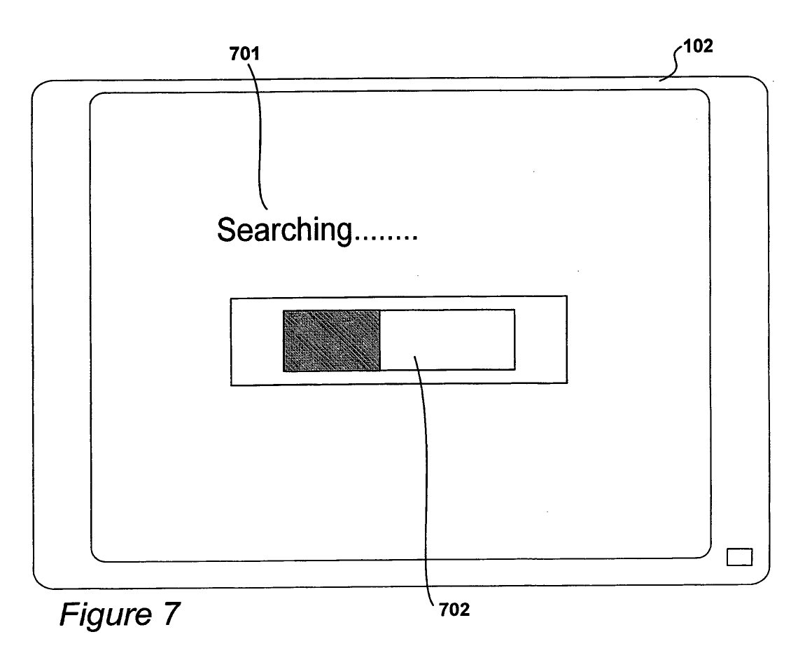

Once the system has received the input string 603, in this example a simple search is selected. In a simple search, no further criteria are provided and thus the entire database is searched for text string 603. This is further described with reference to FIG. 7.

The text string at 603 represents a definition of the audio content of interest to the user. Thus, the user inputs text corresponding with audio content that they wish to locate within assets.

### FIG. 7

Once input has been received as described with reference to FIG. 6, the database is queried at step 503. An example of the appearance of display means 102 at this point is shown in FIG. 7. A message is provided 701 to the user on display means 102 to communicate that the database is being searched. In addition, in this embodiment, a progress bar 702 is provided to illustrate the progress of the search.

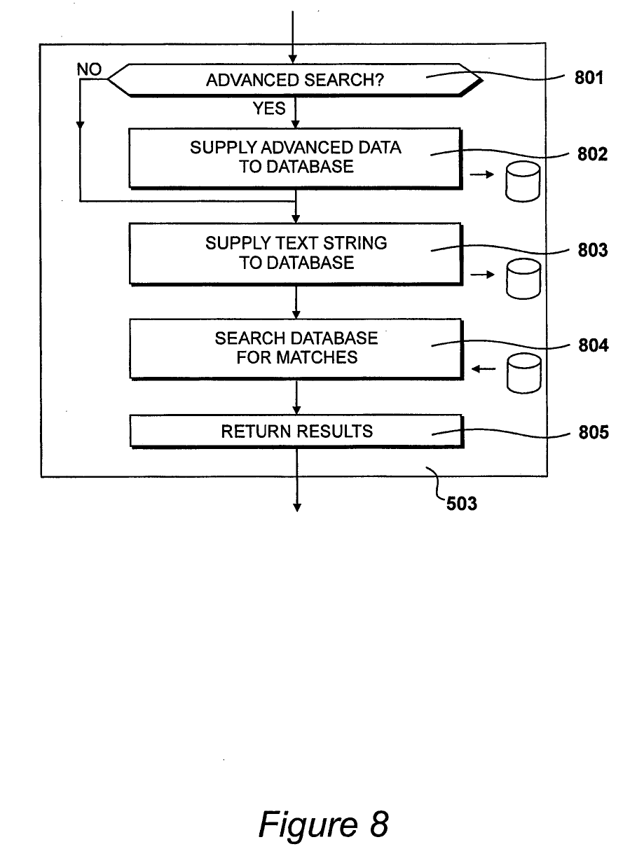

### FIG. 8

An expansion of step 503 described with reference to FIG. 5 is shown in FIG. 8. This step is the querying of the database. At step 801, a question is asked as to whether an advanced search is required. In this embodiment, advanced search is initiated by selecting button 605 with cursor 606. If this question is answered in the affirmative then advanced data is supplied to the database at step 802. The first example being described with a simple search, therefore in this example the question asked at step 801 is answered in the negative and step 802 is omitted. An advanced search, in which step 802 is carried out is described with reference to FIGS. 16 to 25.

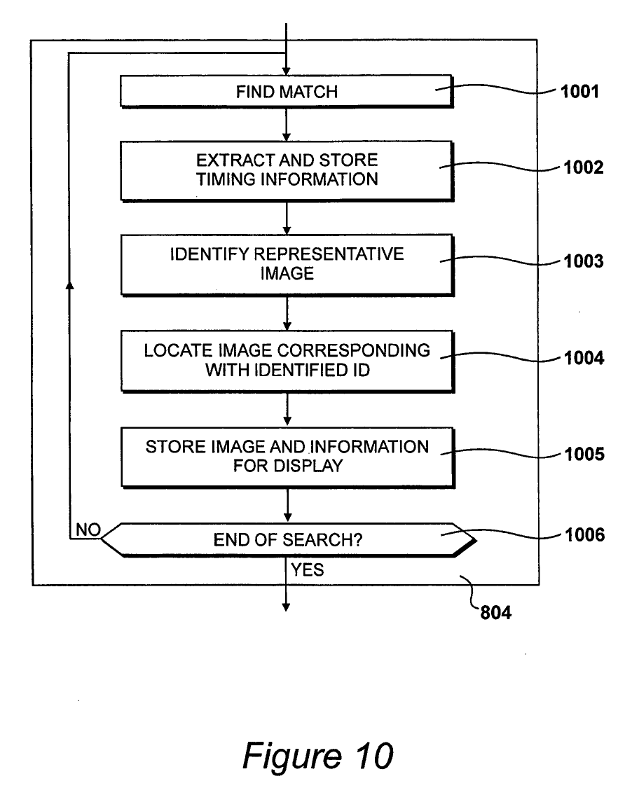

At step 803, irrespective of whether a simple of advanced is being carried out, the text string received as input, in this example string 603 entered into field 602, is supplied to the database. An illustration of the database in this example is shown in FIG. 9. At step 804, the database is searched for matches with the text string supplied at 803. This step is expanded in FIG. 10 and further described with reference to FIGS. 11 to 14. Once this searching has occurred, during which the image shown in FIG. 7 is displayed, the results are returned at step 805. This terminates step 503 and the procedure continues as described with reference to FIG. 5.

### FIG. 9

An example of tables within the database according to the present embodiment is shown in FIG. 9. The first table 901 contains information relating to film assets. For each asset, various pieces of information are stored. In this embodiment, these are: film number, title, director, writer, company, year, aspect ratio, genre, URL and number of stills. In alternative embodiments different combinations of information may be desirable to have stored. The film number field contains a unique identifier for each asset. The title field contains the title of the film, and the director contains the name of the director or directors of the film. The writer field contains the name of the writer and the company field contains the name of the film company. The field year contains the year in which the film is made, and the aspect ratio field stores the aspect ratio at which the film is produced. In this embodiment, the genre field contains an indication of the genre of the film. In alternative embodiments, when assets stored are, for example, television programmes, the genre field may contain series information. The URL field is where Internet links relating to the respective asset could be stored. The final field (number of stills) contains an indication of the number of the still images stored for that film. A still image is extracted from each asset at a predetermined interval throughout the film. For example, an image is extracted every twenty seconds. In the present embodiment, the full asset is not stored within station 101. Instead, the extracted still images are stored, thus significantly reducing memory required. The interval at which the still images are extracted could vary according to how much storage is available, or other desirable factors. Thus, the filed number of stills varies according to the length of the asset.

A further table 902 is also provided. Text representing spoken audio content is stored in table 901. In this embodiment, text is extracted from subtitles and each line of text is stored in table 902. Thus for each instance within table 902 the following data is stored: film number, time and text.

Because of the arrangement of tables, film information is stored once for each asset and each instance within the film table 901 is linked with many instances of line table 902, via the film number field. This one-to-many relationship is illustrated by link 903.

### FIG. 10

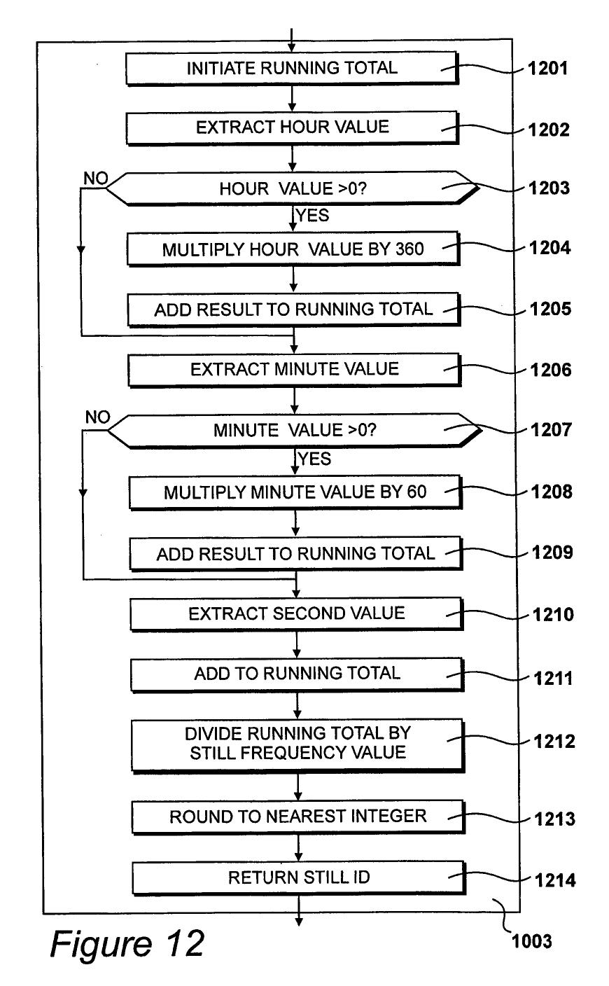

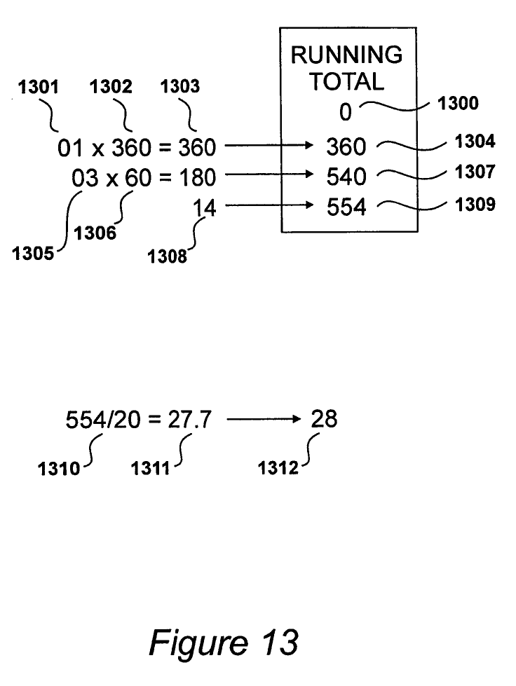

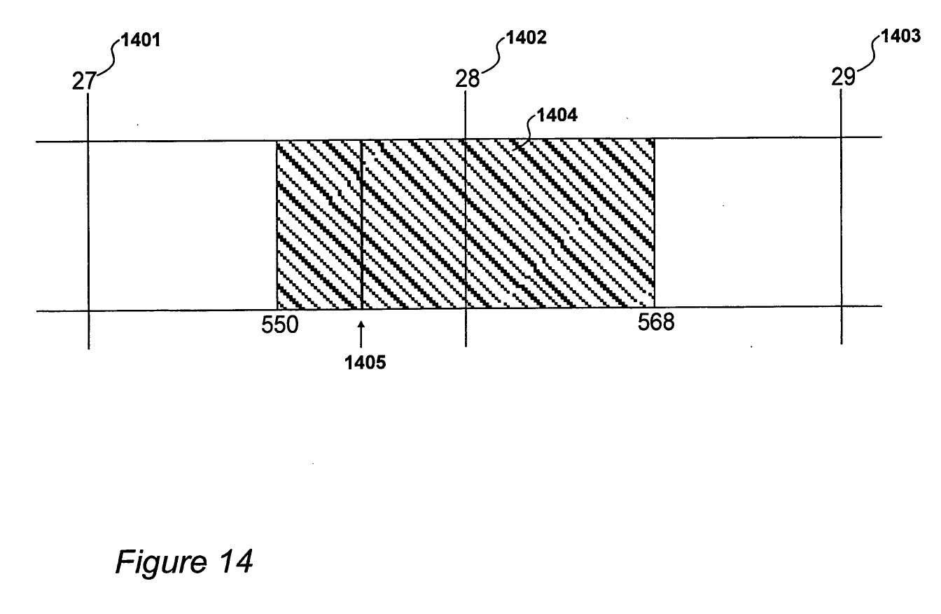

Step 804 illustrated in FIG. 8 where the database is searched for matches is further described in FIG. 10. At step 1001, the database is searched until a match is found. This involves comparing the text string 603 with the text in the line table 902 until a match is found. When such a match is found, the timing information relating to it is extracted at step 1002. In this embodiment, the timing information relates toe the time at which a given subtitle starts to be displayed within an asset. This step is further described with reference to FIG. 11. At step 1003, an image which is representative of the match found at step 1001 is identified. This step is expanded in FIG. 12 and further described with reference to FIG. 13. Once the number of the representative image has been identified at step 1003, the image is located at step 1004. This is further described with reference to FIG. 14. At step 1005, the image and the information relating to the text match found at step 1001, along with film information corresponding with the text match is all stored ready for display. At step 1006 a question is asked as to whether the end of the search has been reached. In this example, the end of the search will be reached when the entire database has been searched. In alternative examples whereby a partial search is being conducted, the end of the search will be reached before the entire database has been searched. If the question asked at step 1006 is answered in the negative then the search continues from step 1001. If the question asked at step 1006 is answered in the affirmative, confirming that the search has ended then step 804 is complete.

### FIG. 11

An example of line table 902 is shown in FIG. 11, populated with data. A first line 1101 shows a film number, in this case “7611”; a display time, in this case “01:02:34”; and the corresponding text, in this case “ . . . so how do we get there?”. Further lines of text are shown at 1102, 1103, 1104, 1105 and 1106. The layout of information contained in this table serves as an example, but in alternative embodiments different configurations would be used as appropriate.

In this example, the text to be searched for is “once upon a time”. Thus, a match is found at line 1104 in table 902. This occurs at step 1001. Subsequently, at step 1002 the corresponding timing information for line 1104 (in this case “01:03:14”) is extracted. This timing information is used at step 1003 to identify a representative image. In this example a representative image is considered to be the image closest in timing to when the line of text occurs in the asset. Hence, given that the line of text refers to spoken audio content, the representative image is an image displayed closest (out of the images available) to when the line is spoken in the asset.

### FIGS. 12 & 13

Step 1003 described with reference to FIG. 10 is further expanded in FIG. 12. FIG. 12 represents the conversion of the time extracted from table 902 as described with reference to FIG. 11 into seconds, such that the representative image may be identified. At step 1201, a variable is initiated to act as a running total throughout the steps contained as part of step 1003. This is illustrated at step 1300 in FIG. 13. At step 1202 the hour value is extracted from the time of the occurrence of the text string. In this example the hour value is one and this is shown at 1301 in FIG. 13. At step 1203 a question is asked as to whether the hour value is greater than zero. If this question is answered in the affirmative then the hour value is multiplied by three hundred and sixty at step 1204. This is shown at 1302 in FIG. 13. If the question asked at step 1203 is answered in the negative, then steps 1204 and 1205 are omitted. At step 1205 the result, shown in FIG. 13 at 1303 is added to the running total. This is shown at 1304.

At step 1206 the minute value is extracted. This is shown at 1305 in FIG. 13, and in this example the value is three. At step 1207 a question is asked as to whether the minute value is greater than zero. If this question is answered in the affirmative then the minute value is multiplied by sixty at step 1208. This is shown at 1306 in FIG. 13. The result of this multiplication is added to the running total at step 1209, as shown at 1307. In contrast, if the question asked at step 1207 is answered in the negative then steps 1208 and 1209 are omitted and proceedings continue from step 1210.

At step 1210 the second value is extracted, as shown at 1308 in FIG. 13. In this example this value is fourteen. This value is added to the running total at step 1211 as shown at 1309 in FIG. 13. Thus the running total represents the total number of seconds up until the display of the selected text string. In this case the total is five hundred and fifty-four.

At step 1212 the final running total is divided by a preset value which indicates the frequency at which still images were extracted from the asset. In this example, images were extracted at intervals of twenty seconds, and therefore the still frequency value is twenty and the division is shown at 1310 in FIG. 13. At step 1213, the result of the division undertaken at step 1212 is rounded to the nearest integer. In this example, the result of the division shown at 1311 is twenty-seven point seven therefore the result of rounding gives the integer twenty-eight shown at 1312. At step 1214 this integer is returned as the still ID. Therefore, the still that must be located in this example is still number twenty-eight. In the present embodiment, if the division at step 1212 results in a number ending in point five, it is rounded upwards. Thus, the results of the totality of step 1003 is that a still image is identified which is closest to the timing of spoken audio content within an asset which relates to the selected line of text.

### FIG. 14

A diagrammatic representation of a timeline is shown in FIG. 14. Still image numbers 1401, 1402 and 1403 are shown which correspond with still images numbers 27, 28 and 29 respectively. The shaded area 1404 illustrates that any text spoken between timings of five hundred and fifty seconds and five hundred and sixty-eight seconds will correspond with still image number 28. Thus, the image to be displayed will not necessarily represent the exact time at which the audio content occurs in the asset which is represented by the text string, but dependent upon the frequency of still images extracted it will be representative. Arrow 1405 illustrates on the timeline the position of text string shown at 1104 which is the subject of the current example.

### FIG. 15

Step 505 described with reference to FIG. 5 identifies the display of results. This is shown in FIG. 15. Once the database has been searched to identify instances of the received text string which defines the audio content of interest, and representative images have been identified and located, the results are paginated and displayed as shown in FIG. 15. Display means 102 is shown with, in this case the first three results shown at 1501, 1502 and 1503. Result 1501 was found as described with reference to FIG. 11. Text string 1104 is shown which matches text string 603 received as input from the user at step 502. The film name 1504 and year of production 1505 are shown, which have been extracted from table 901. In addition, the image identified with reference to FIGS. 12, 13 and 14 is shown at 1506.

Thus, the result of receiving a text string to define audio content of interest and searching a database to identify instances of the received text string is the display of images taken from respective video assets which contain each of the instances of the text string.

### FIG. 16

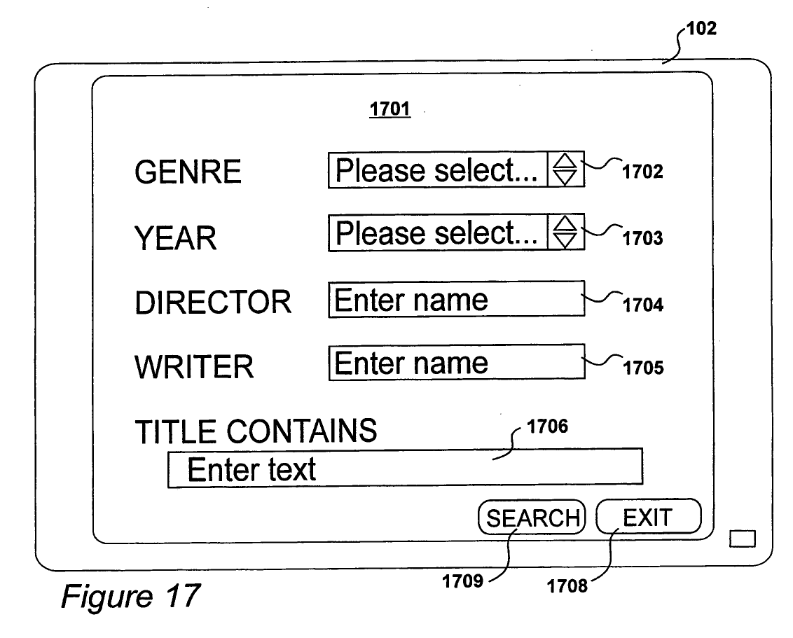

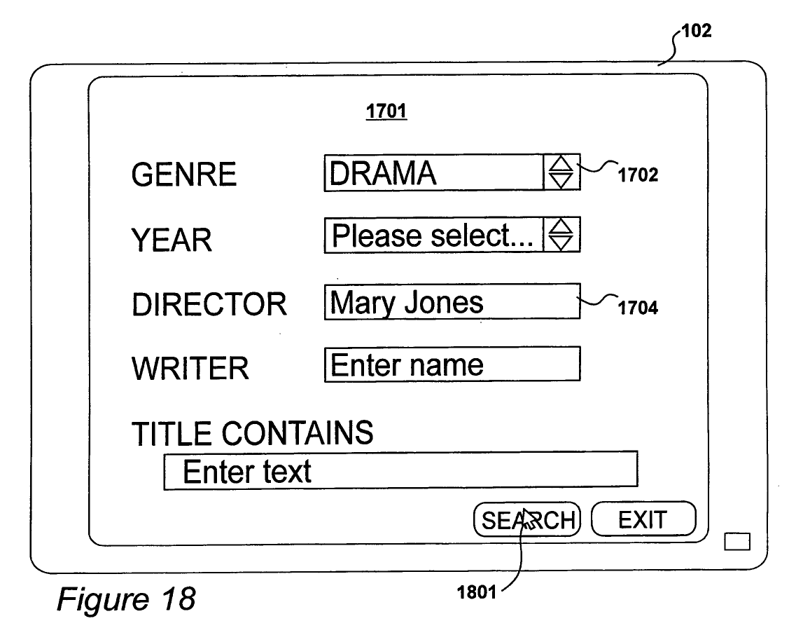

A second example of a search function is described with reference to FIGS. 16 to 25. FIG. 16 shows a similar view to FIG. 6. The view of FIG. 16 represents step 501 whereby a user is prompted for input. Display means 102 displays an image including user prompt 1601 and text field 1602. In this example text string 1603 has been received as user input, via keyboard 106. The option selected in this example is advanced search, the selection of which is shown at 1604. In this example, step 502, the receipt of user input of selection criteria, comprises not only receiving the input shown at 1603, but also receiving further selection criteria in the form of an advanced search. This will be further described with reference to FIGS. 17 and 18.

### FIG. 17

The result of receiving user input selecting the advanced search option is shown in FIG. 17. Display means 102 is displaying an option screen 1701. Depending upon the configuration of station 101, this option screen can be laid out in many different ways. In this example, a series of drop down lists are provided. In alternative embodiments, check boxes, radio buttons or any other form of selection could be provided. Drop down lists 1702 and 1703 provide for selection of genre and year respectively. In addition, text fields are provided at 1704, 1705 and 1706 to allow user input of director name, writer name and title text respectively. The text received at 1603 in FIG. 16 will be searched for within the text strings stored as described with reference to FIG. 9 in table 902, representing audio content. In contrast, the input received in response to screen 1701 will result in a database search within the film table 901 as described with reference to FIG. 9. This, the result of receiving user input into option screen 1701 is to narrow the field of search, such that only a portion of the database is then searched for the text string input at 1603, in this case “Paris”.

Also provided on option screen 1701 is an exit button 1708 alongside a search button 1709, which effectively indicates a user preference to continue.

### FIG. 18

The option screen 1701 described with reference to FIG. 17 is shown in FIG. 18, after user input has been received. In this case, input has been received at 1702 selecting the genre of drama from the drop down list, and input has been received at 1704 in the form of the text “Mary Jones” being entered into the director field. The result of this input having been received is that, in combination with the text string received at 1603, the search that will take place is amongst those assets in the database which are classified as being within the drama genre, have Mary Jones as a director, and contain within the audio content the text string “Paris”. At 1801, the cursor has been used to select the search option therefore, as a result of this input, a search will be conducted.

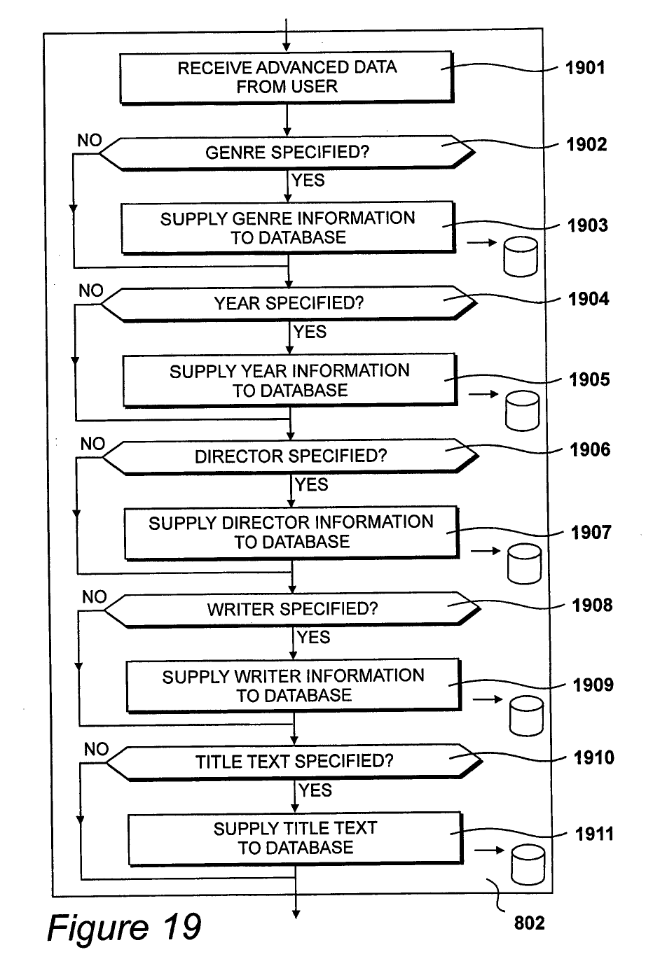

### FIG. 19

An expansion of step 802 described with reference to FIG. 8 is shown in FIG. 19. In this example, an advanced search has been selected. Therefore, at step 801, the question asked will be answered in the affirmative and at step 802 advanced data will be supplied to the database.

At step 1901, advance data is received as input from the user. This occurs as a result of user input to option screen 1701, and selection of the search option as shown at 1801. At step 1902 a question is asked as to whether the genre has been specified. If this question is answered in the affirmative then genre information is supplied to the database at 1903. In contrast, if the question asked at step 1902 is answered in the negative then step 1903 is omitted. At step 1904 a question is asked as to whether a year has been specified. If this question is answered in the affirmative then the year information is supplied to the database at step 1905. If the question asked at step 1904 is answered in the negative then step 1905 is omitted.

At step 1906, a question is asked as to whether a director has been specified. If this question is answered in the affirmative then the director information is supplied to the database at 1907. In contrast, if this question is answered in the negative then step 1907 is omitted. At step 1908, a question is asked as to whether a writer has been specified. If this question is answered in the affirmative then writer information is supplied to the database at step 1909. If the question asked at step 1908 is answered in the negative then step 1909 is omitted. At step 1910 a question is asked as to whether title text has been specified. If this question is answered in the affirmative then title text is supplied to the database at 1911. If the question asked at step 1910 is answered in the negative then step 1911 is omitted.

Thus, the result of the steps described with reference to FIG. 19 is that the necessary information is supplied to the database such that only a subset of the assets contained within the database are to be searched.

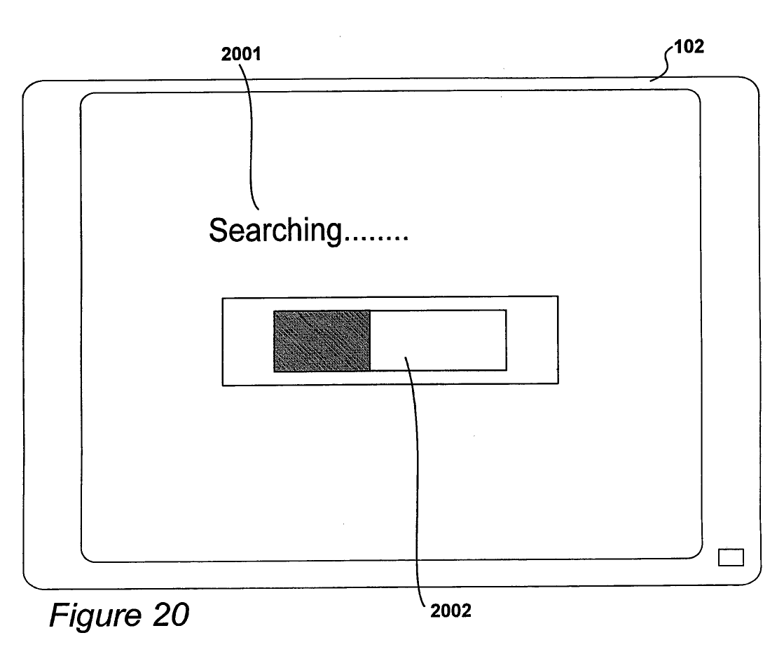

### FIG. 20

After the advanced data has been supplied to the database, at step 802, as described with reference to FIG. 19, the text string input at 1603 is supplied to the database at step 803. The database is then searched at step 804, and while this is taking place display means 102 shows the image illustrated in FIG. 20. A message is provided to indicate that the database is being searched at 2001 and at 2002 a progress bar is provided indicating how far the search has progressed.

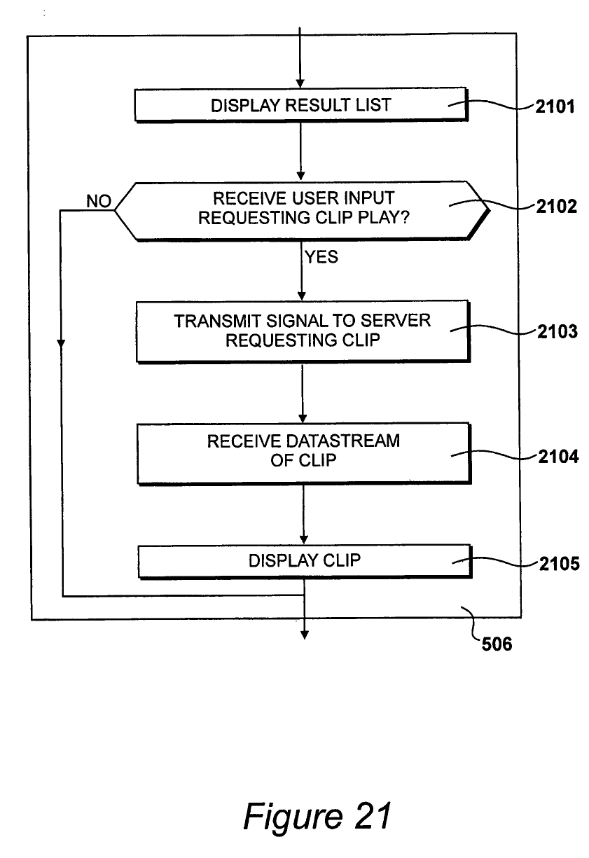

### FIG. 21

Following the search that takes place at step 804 the results are returned at step 805. This completes step 503 shown in FIG. 5, and therefore the next stage, when matches are found and therefore the question asked at step 504 is answered in the affirmative, is to paginate the results at 505 and display them at 506. FIG. 21 shows an expansion of step 506 for the present example.

In this embodiment, station 101 is provided with a connection to a network, such as the Internet. This provision means that whilst station 101 does not store entire assets locally, at the receipt of appropriate user input it can request clips of the assets to be received from the network. In alternative embodiments, station 101 may have a significantly larger amount of storage and may be able to store entire assets locally. In addition, in the present embodiment only short clips of assets may be displayed, but in alternative embodiments entire assets may be viewable.

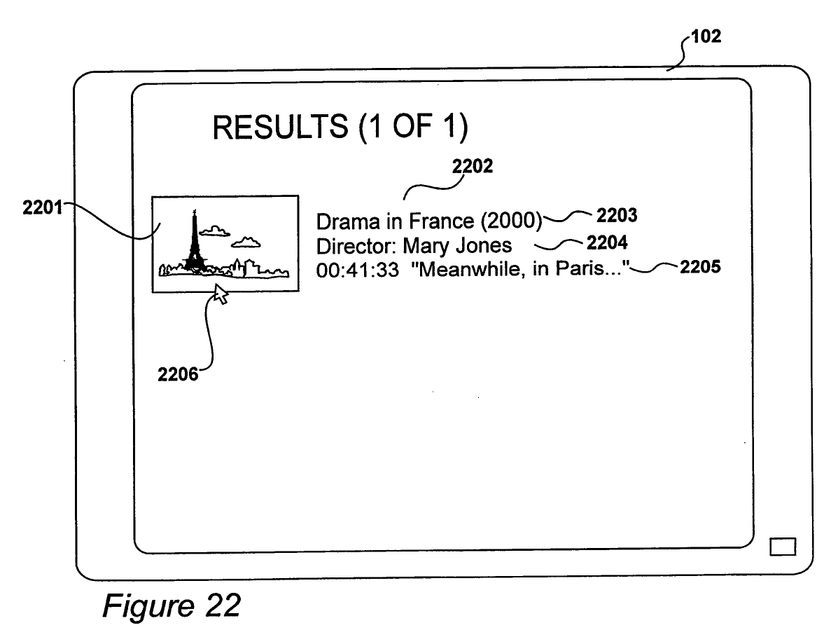

At step 2101, the result list is displayed. This is shown in FIG. 22. At step 2102 a question is asked as to whether user input has been received requesting that a clip is played. If this question is answered in the affirmative then control passes to step 2103. If the question asked at 2102 is answered in the negative, indicating that no user input has been received requesting clip play then steps 2103, 2104 and 2105 are omitted.

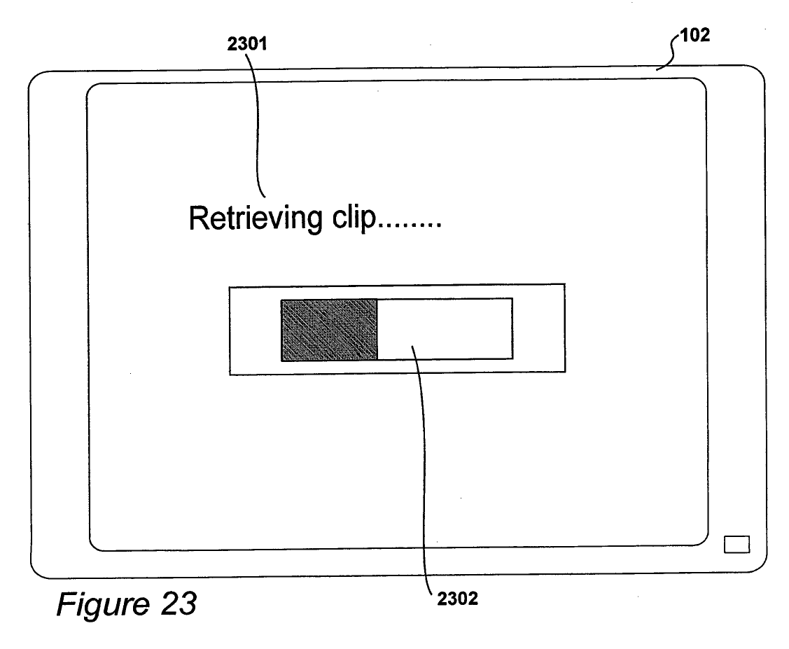

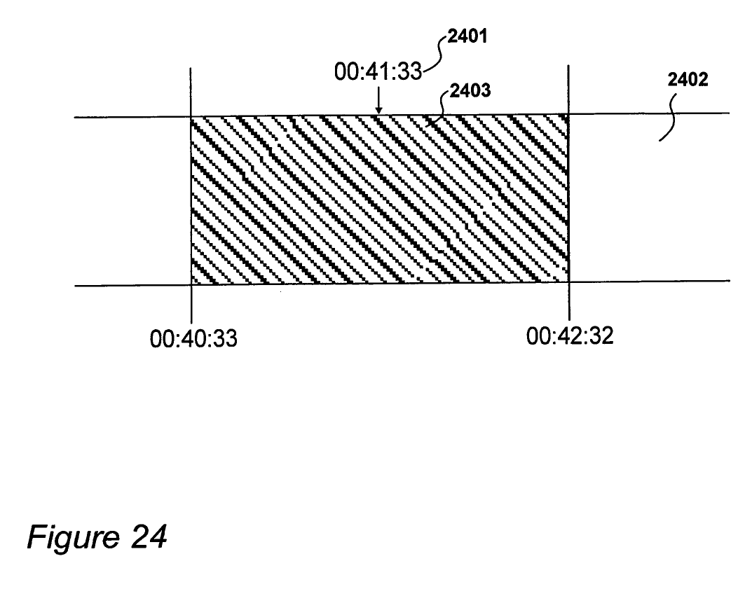

At step 2103 a signal is transmitted from station 101 to a network server or similar apparatus where the clip is stored. In alternative embodiments, this may be a secondary source of memory stored internally within station 101. Whilst this is occurring, a screen is displayed as illustrated in FIG. 23. FIG. 24 illustrates the time frame of clip that is retrieved.

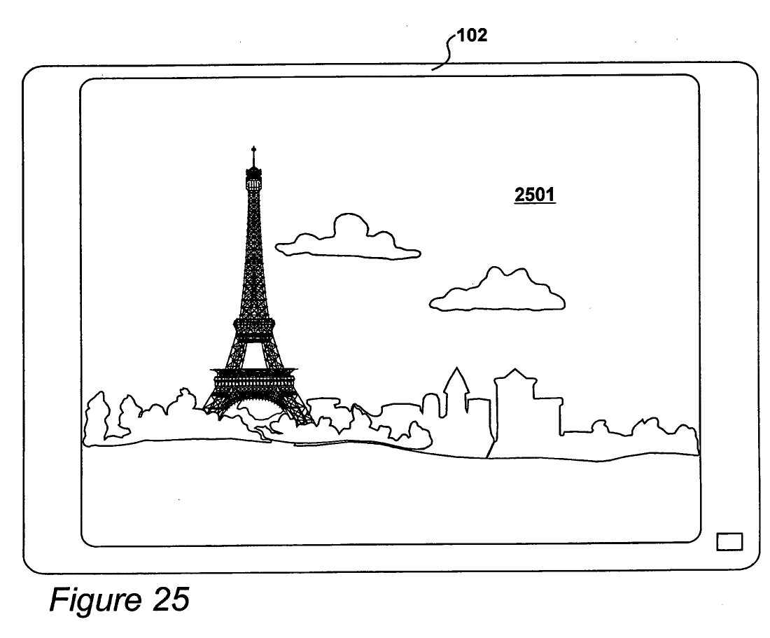

At step 2104 a data stream of the clip is received. In alternative embodiments, this may be transmitted as a packet or series of packets rather than being streamed directly. At step 2105 the clip is displayed on display means 102, as shown in FIG. 25.

### FIG. 22

The result list displayed at step 2101 described with reference to FIG. 21 is shown in FIG. 22. In this example, only one result has been found. As a result of user input received at step 502, specifying that a search was required for assets containing the text string “Paris”, and narrowing the search to the subset of assets classified within the genre drama and directed by Mary Jones. An image 2201 from the asset “Drama in France” is shown, which was selected by the process described in the earlier example with reference to FIGS. 12, 13 and 14. Thus, the image shown at 2201 is a representative image stored on station 101 from the pre-extracted series of images for the asset found. Information about the asset is displayed at 2202, in this example the configuration has been set to display the title and year at line 2203, the director at line 2204 and the instance of the received text string identified within the asset at line 2205.

In the present embodiment, input received from the user moving the cursor 2206 onto image 2201 and pressing a select button results in playing a clip from the asset. Thus, the user input requesting clip play is received, and the question asked at step 2102 is, in this example, answered in the affirmative. The results of this is that a signal is transmitted to the server at step 2103 requesting the clip and this procedure is further described with reference to FIGS. 23 and 24.

### FIG. 23

Display means 102 is shown in FIG. 23 displaying an image indicating that the clip is being retrieved. A message 2301 is provided and a progress bar is shown at 2302. The amount of time taken to retrieve the clip will vary dependent upon the speed of the network connection, particularly the bandwidth. In alternative embodiments, various holding pages are displayed whilst the clip is being retrieved, such as advertisements or other entertaining images.

In a further alternative embodiment, when the search results are displayed, corresponding clips are downloaded automatically and stored locally. This enables the clips to then be accessed quickly if user input is received requesting that they be displayed.

### FIG. 24

In the present embodiment, a clip is retrieved upon receipt of user input. The length of clip is predetermined, and in this example is one minute. FIG. 24 illustrates the selection of which portion of the asset will be displayed as a clip. At 2401 the time at which the instance of the received text string is contained within the asset. A timeline is shown at 2402 and the shaded portion 2403 identifies the selection of one minute of the asset, whereby the time shown at 2401 is in the middle of the clip. Thus, the clip is taken from thirty seconds before the instance of the text string to thirty seconds after. In alternative configurations different lengths of clips could be predetermined, or the length of clip could be selected by the user. In addition, in alternative embodiments it may be preferable to show, for example, less of the asset from before the instance of the text string and more from after, or vice versa. Thus, for example the system could be configured such that the selected clip would run from ten seconds before the instance of the text string until fifty seconds afterwards.

### FIG. 25

At step 2105, the clip is displayed. This is shown in FIG. 25. Display means 102 shows image 2501 and plays the clip. In the presence embodiment, the clip may be viewed only once. The clip is received as a data stream and played via a Flash player or similar. In alternative embodiments, the clip may be stored locally and replayed, or streamed from a network repeatedly.

### FIG. 26

An expansion of step 307 described with reference to FIG. 3 is shown in FIG. 26. When user input is received to the effect that trivia is selected, at 402 on FIG. 4, the steps illustrated in FIG. 26 are taken. At step 2601 the trivia menu is displayed. This is shown in FIG. 27. At step 2602 user input is received of criteria of assets to be included in the trivia round. In effect, user input can be received to either include all assets contained within the database or to include a subset according to user defined criteria.

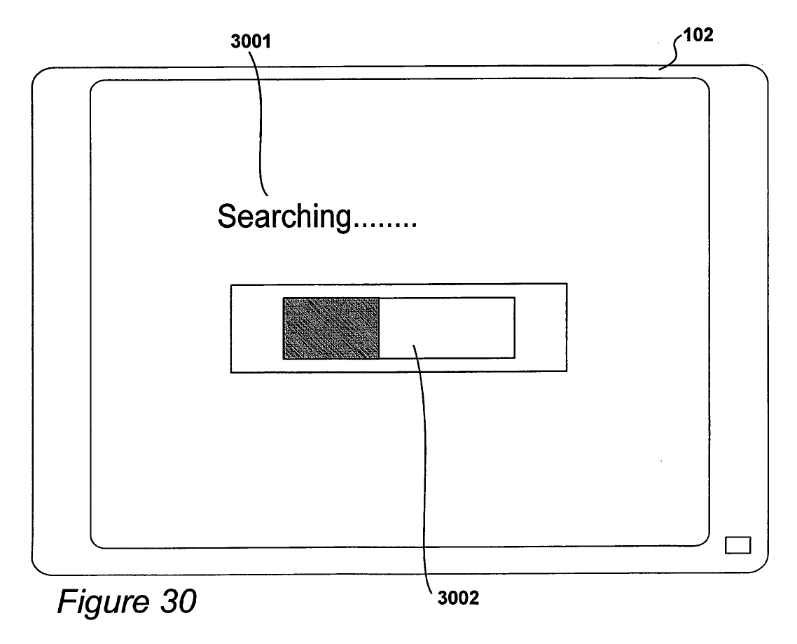

At step 2603 user input is received identifying the text string defining the audio content of interest. As a result of user input received at 2602 and 2603 a query is formulated at 2604. At step 2605 the database is queried to return matches with the query formulated at 2604. During this procedure an image is displayed such as that shown in FIG. 30. This effectively defines a subset of assets for this trivia round.

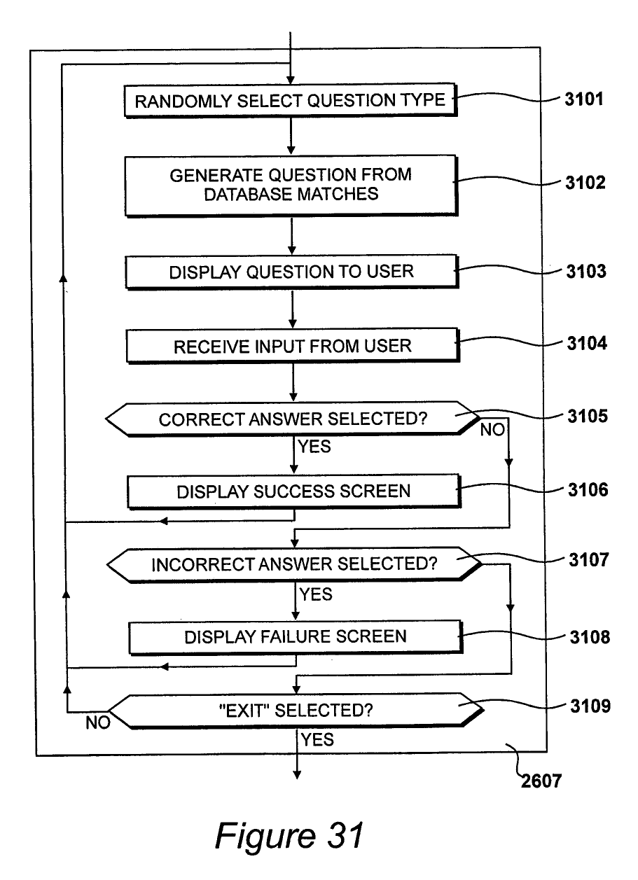

At step 2606 a question is asked as to whether any matches have been found. If the question asked at 2606 is answered in the negative, a message is displayed at step 2607 to the effect that no matches have been found and control passes back to step 2601 at which the trivia menu is displayed again. If the question asked at 2606 is answered in the affirmative, indicating that matches have been found then a trivia round can be run and this occurs at step 2607. Step 2607 is further described with reference to FIG. 31. At step 2608 a question is asked as to whether user input has been received to exit. If this question is answered in the negative then control passes back to step 2601 and the trivia menu is displayed for a further trivia game. If the question asked at step 2606 is answered in the affirmative then the run trivia step 307 is complete.

### FIG. 27

At step 2601, a trivia menu is displayed. This is illustrated in FIG. 27. Display means 102 displays trivia menu 2701. In this embodiment, trivia menu comprises a series of check boxes 2702 that represent selection of various genres. In this example any number of genres can be selected, and the more genres that are selected the larger the subset of assets that will be included. In addition, text field 2703, 2704 and 2705 are provided for user selection of year, director and title respectively. In alternative embodiments, a further function may be provided to allow selection of, for example a series of films that are related but that do not necessarily contain common text in their titles. In addition, further genres and other options reflecting the data stored in the table such as table 901 can be offered. A further check box 2706 is provided which represents the selection of all films (assets) in the database. If this box is selected then input into any of the other check boxes or text fields is either not allowed or is ignored as it represents searching the entire database. Options to continue (2707) and exit (2708) are also provided.

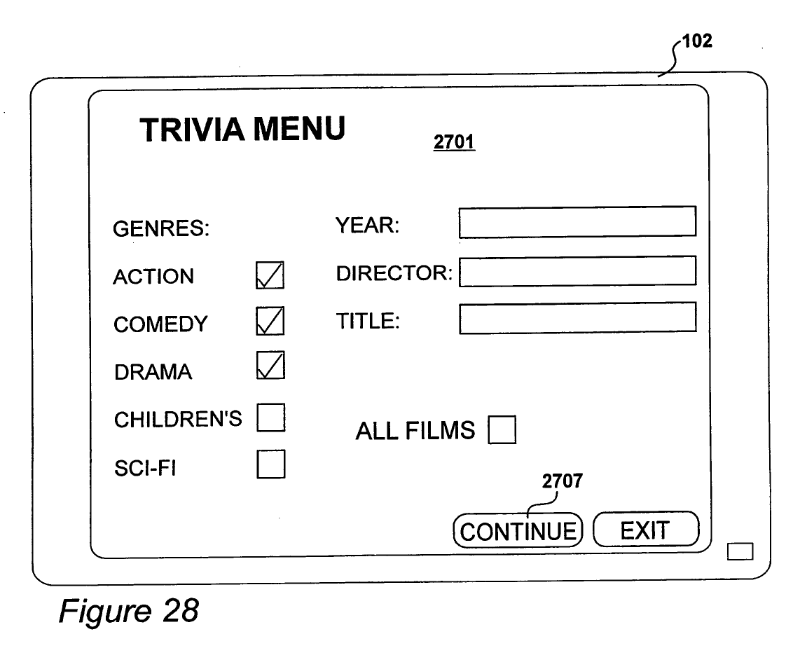

### FIG. 28

A similar view to that shown in FIG. 27, with the addition of received user input is shown in FIG. 28. In this example, input has been received from the user indicating a selection of genres action, comedy and drama to create the subset of assets for the trivia round. Once this data has been received and a user has finished making selections, input is received selecting the continue function 2707 and at this point step 2602 described in FIG. 26 is complete.

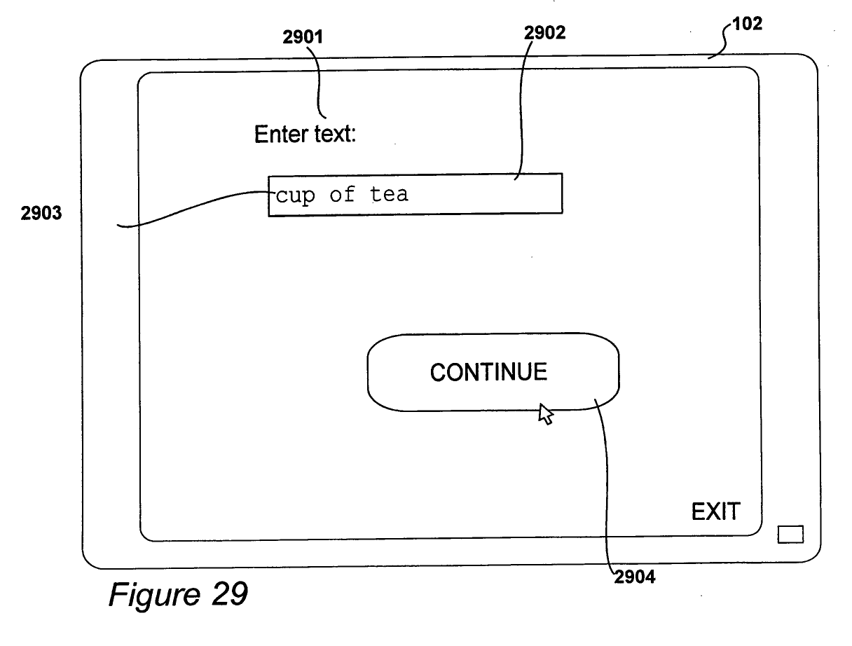

### FIG. 29

An example of the running of step 2603 in FIG. 26 is shown in FIG. 29. Text is provided at 2901 prompting a user to enter text into text field 2902 to define the audio content of interest. In this example, text 2903 has been received which comprises the phrase “cup of tea”.

User input is received to indicate the desire to continue by selection of button 2904 and at this stage step 2603 is complete. A query is then formulated at step 2604 as a result of input received from a user as described with reference to FIGS. 28 and 29.

### FIG. 30

Once the query has been formulated at step 2604, the database is queried at step 2605. Whilst this is taking place a screen such as that shown in FIG. 30 is displayed. Display means 102 shows message 3001 along with progress bar 3002. If matches are found then the question asked at 2606 is answered in the affirmative and a trivia round is run at step 2607. This is further described with reference to FIG. 31.

### FIG. 31

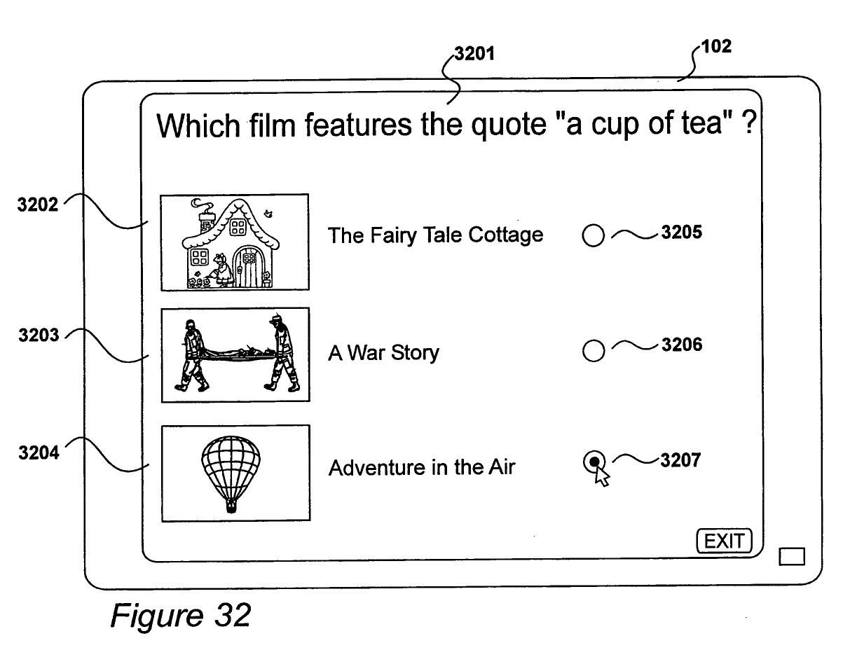

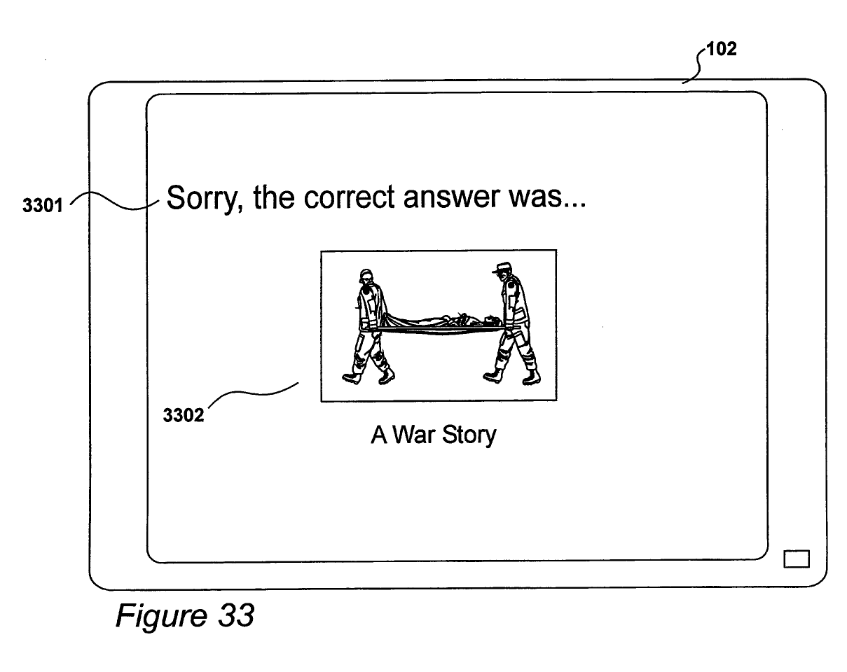

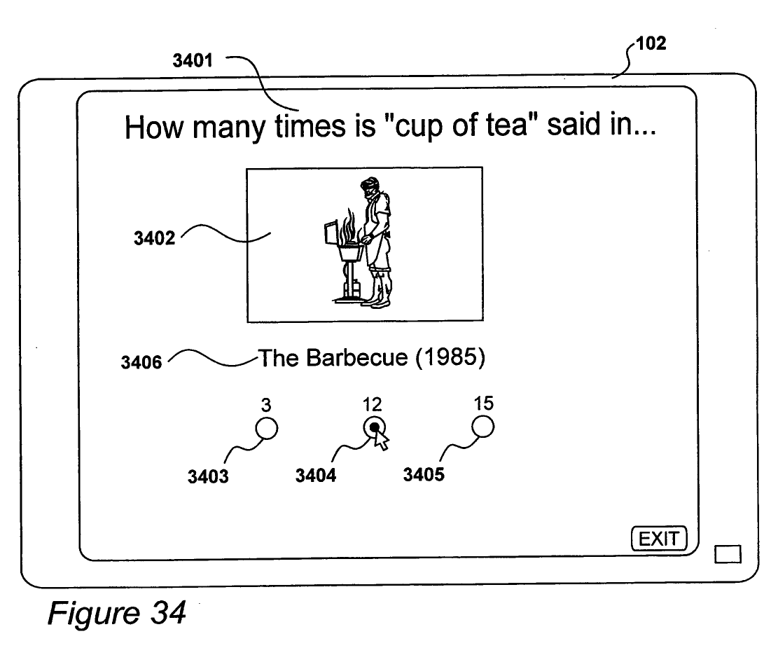

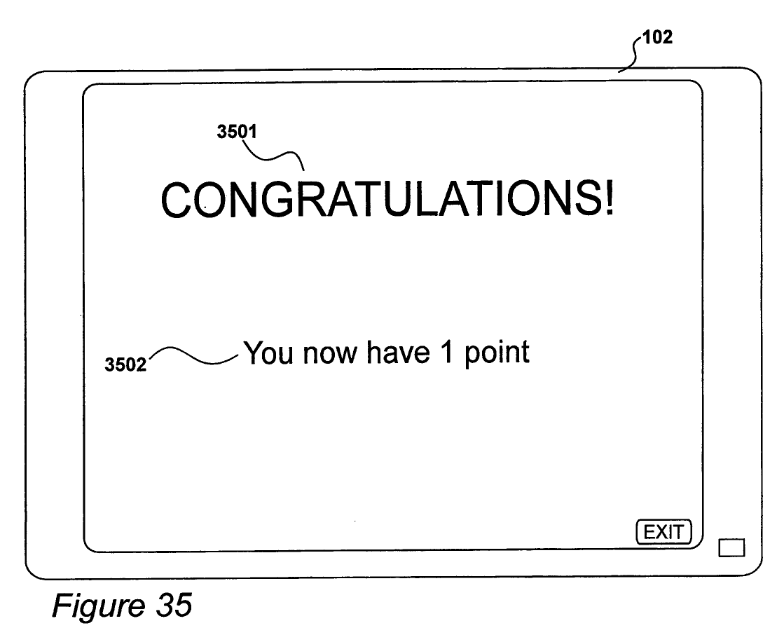

Step 2607 described with reference to FIG. 26, where a trivia round is run is further expanded upon in FIG. 31. At step 3101 a question type is selected. In this example the selection is random, but in alternative embodiments user preferences are expressed in terms of which question types are desirable. Examples of question types are described with reference to FIGS. 32 and 34, although many other types can be utilised. At step 3102 a question is generated from the database matches produced during step 2605. Thus, questions generated are from the subset of assets which fulfil the criteria received as user input at stage 2602 and the text string defining audio content of interest received at stage 2603. Once a question has been generated at step 3102, this question is displayed to a user at step 3103. Examples of this are shown in FIGS. 32 and 34. Input is received from a user at step 3104 identifying their chosen answer. At step 3105 a question is asked as to whether input has been received identifying the correct answer. If this question is answered in the affirmative then a success screen is displayed at step 3106, as illustrated in FIG. 35. In the present embodiment, the success screen is displayed for a fixed period of time, for example ten seconds. In alternative embodiments an exit function may be provided or the timing of the display of the success screen may vary. If the question asked at step 3105 is answered in the negative then control passes to step 3107, at which a question is asked as to whether an incorrect answer was selected. If this question is answered in the affirmative then a failure screen is displayed at step 3108, as illustrated in FIG. 33. In the present embodiment, the failure screen is displayed for a fixed period of time. After display of either the success screen at step 3106 or the failure screen at step 3108, as appropriate, control passes back to step 3101 and a further question is displayed.

If the question asked at step 3107 is answered in the negative, indicating that no answer has been selected then a question is asked at step 3109 as to whether the exit option has been selected. If this question is answered in the affirmative then step 2607 is complete. If the question asked at step 3109 is answered in the negative then, in this embodiment after a fixed time period, a new question is displayed. Therefore, if no input is received the display reverts to a new question and additionally, in the present configuration if no input at all is received for a fixed period, for example one minute, then display reverts to the top level menu as shown in FIG. 4.

### FIG. 32

A first example of a question generated at step 3102 is shown in FIG. 32. Text 3201 is displayed on display means 102 together with possible answers 3202, 3203 and 3204. Each with, in this example, a random representative image selected from each asset. Given that the question in this example involves identifying which film features the given quote, the alternative answers are selected randomly from the rest of the database excluding those assets included in the query as satisfying the user defined criteria. In this example, radio buttons 3205, 3206 and 3207 are provided, configured such that only one option may be selected. In this example, user input has been received indicating a choice of radio button 3207 that corresponds with answer 3204. In this embodiment, once an answer has been selected there is no opportunity for altering the answer.

### FIG. 33

The result of receipt of user input as described with reference to FIG. 32 is illustrated in FIG. 33. Display means 102 is displaying a failure screen that, in this example, includes a failure message 3301 and an indication of the correct answer at 3302, along with the representative image corresponding with the correct answer. In alternative embodiments, and dependent upon whether entire assets are available to station 101, a clip may be automatically played at this point. The clip could be selected in accordance with procedures described with reference to FIG. 24 above. This clip could be displayed as part of a failure screen or instead of a failure screen or before or after a failure screen.

### FIG. 34

A further example of a question generated at step 3102 is shown in FIG. 34. Question text 3401 is displayed on display means 102 together with an image 3402 and possible answers 3403, 3404 and 3405. In this example, image 3402 is from a film (asset) which matches with the query generated at step 2601 in response to user input, and the title of that asset is shown along with the year of production at 3406. In order to generate questions of the type shown in FIG. 34, statistical analysis must be performed on the results of the query generated at 2604. This analysis takes place during the step at which the question is generated (3102), and is therefore performed as required. This sort of simple analysis, counting the instances of the received text string within the video asset is performed on the matches to the query. Data, such as in this case the number of occurrences of the received text string in an asset, is not, in the present embodiment stored prior to question generation. In this example, user input has been received identifying answer 3404, indicating that a selection has been made that the received text string is spoken twelve times in the selected asset.

### FIG. 35

An example of a success screen displayed at step 3106 is shown in FIG. 35. Display means 102 shows success message 3501 along with, in this example, a message relating to the current point score achieved by the user.

In alternative embodiments, station 101 may be configured to interact with further similar stations such that a multi-user trivia round may occur, whereby points are awarded to users who answer the most correct answers or give the answers in the shortest time. Dependent upon the network connectivity of station 101 this could take place on a local, national or international basis.

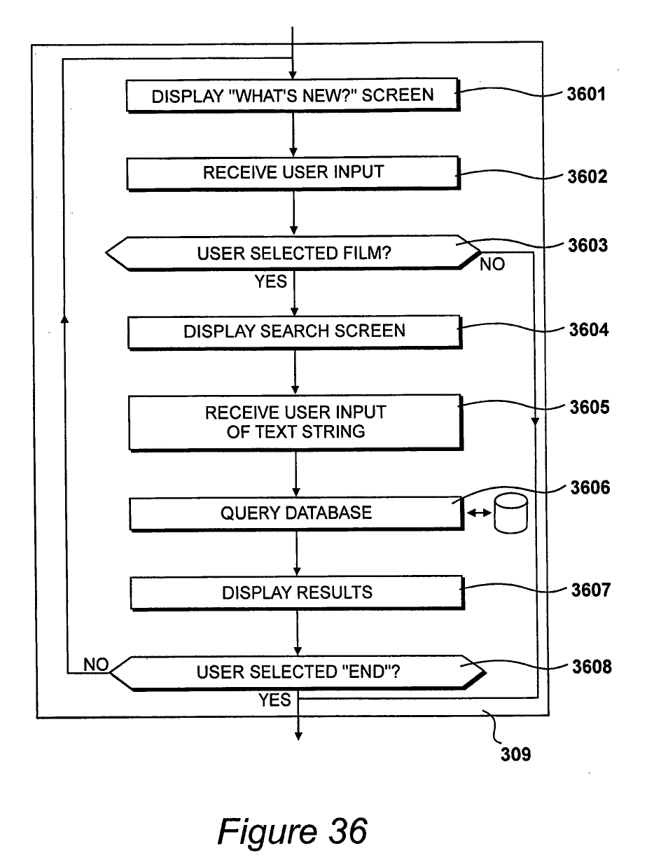

### FIG. 36

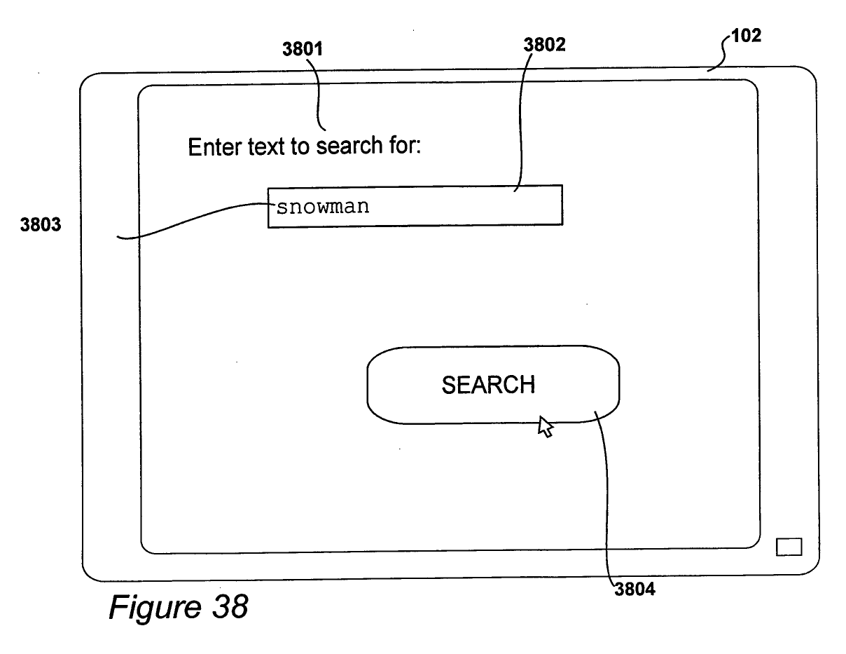

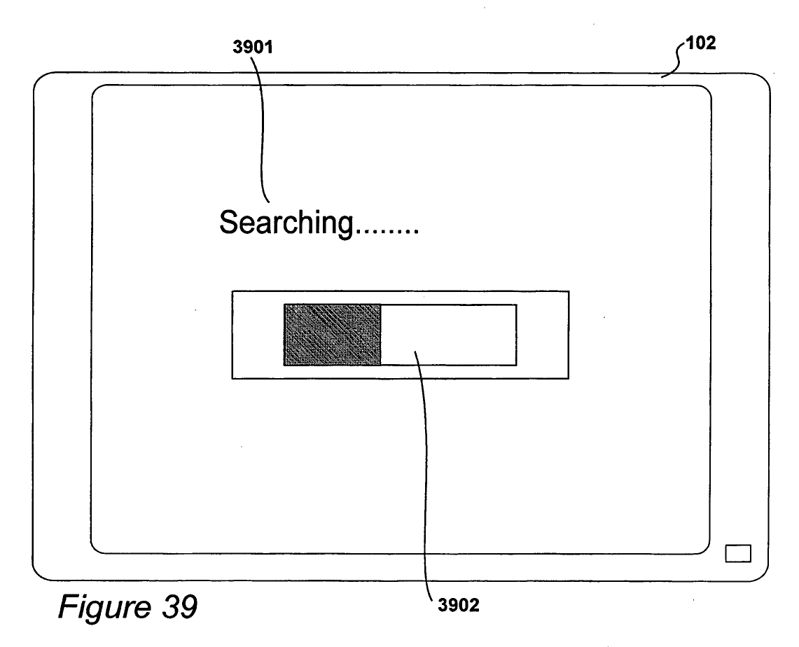

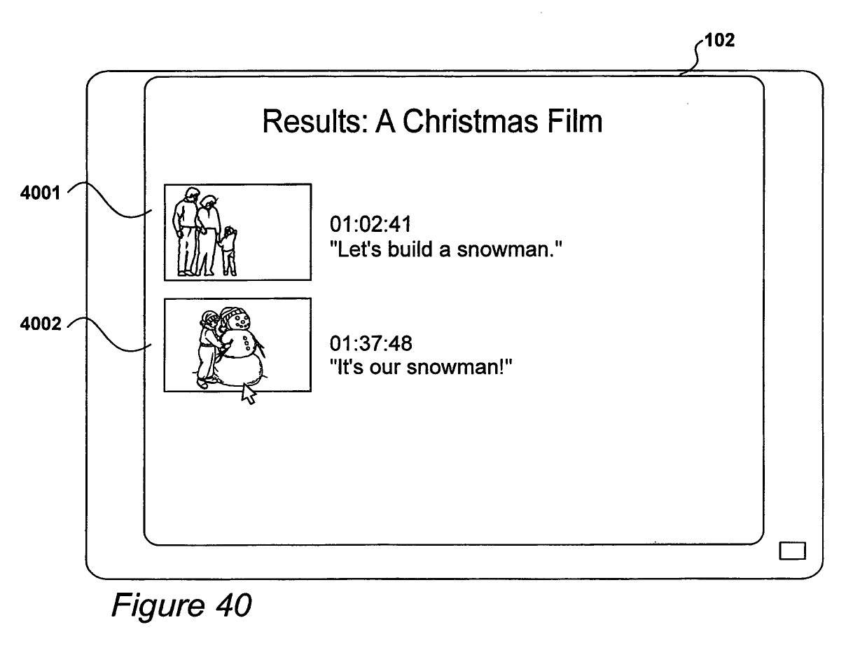

Step 309 described with reference to FIG. 3 is expanded in FIG. 36. At step 3601 a “What's new?” screen is displayed. An example of this is illustrated in FIG. 37. A selection of new additions to the database is displayed with representative images. In an alternative embodiment, instead of a “What's new?” function a random function could be provided whereby a random selection of films from the database are presented. At step 3602 user input is received and at step 3603 the question is asked as to whether the user has indicated interest in a film. If this question is answered in the affirmative then a search screen is displayed at step 3604. At step 3605 user input is received indicating a text string representing audio content of interest (shown in FIG. 38) and at step 3606 the database is queried, searching for instances of the received text string within the selected asset, as shown in FIG. 39. The results are displayed at step 3607 as shown in FIG. 40, and a question is asked at step 3608 as to whether input has been received indicating that the user wishes to end the “What's new?” function. If this question is answered in the negative then the “What's new?” screen is displayed again. If this question is answered in the affirmative then step 309 is complete. If the question asked at step 3603 is answered in the negative then step 309 is complete.

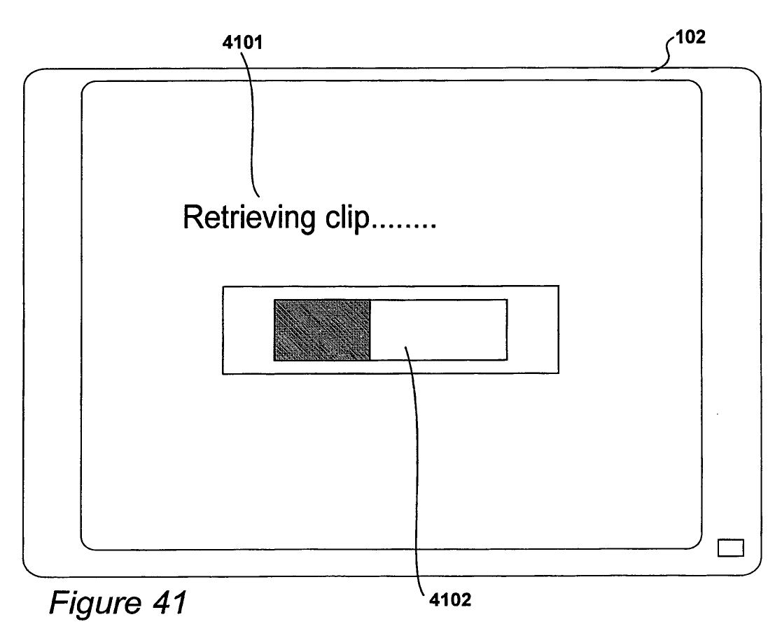

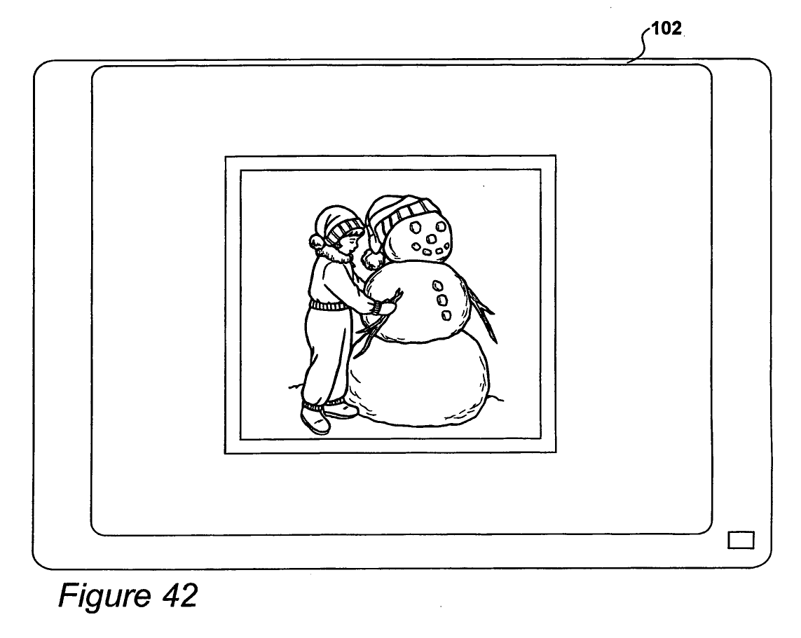

In the present embodiment, step 3607 to display results involves the steps described with reference to FIG. 21 taking place at step 506. Therefore, if user input is received requesting clip play then a clip may be requested and subsequently displayed to a user. This is shown with reference to FIGS. 41 and 42.

### FIG. 37

An example of a “What's new?” screen displayed at step 3601 is shown in FIG. 37. Display means 102 shows examples of films recently added to the database along with images extracted from the still images stored for each asset. In an alternative embodiment, the images shown at 3701, 3702 and 3703 are images from the title sequences of the films (assets) rather than images from the content of the films. In this example, receiving user input selecting an image completes step 3601. In this case input is received selecting image 3701, which relates to the asset “A Christmas Film”.

### FIG. 38

Once user input has been received selecting a film as described with reference to FIG. 37, a search screen is displayed such as that shown in FIG. 38. Display means 102 displays a search prompt 3801 along with a text field 3802. In this example, user input has been received providing the text “snowman” at 3803. This input is indicative of a user requirement to search the film represented by image 3701 (A Christmas Film) for instances of the text string “snowman” defining respective audio content. Hence searching for instances of the word “snowman” being spoken. Once user input of text is received as shown at 3803, user input is received indicating a desire to search by selection of button 3804.

### FIG. 39

Once user input identifying a chosen film and a text string defining audio content of interest have been received, the database is queried at step 3606. Whilst this query is taking place a search screen is displayed such as that shown in FIG. 39. Display means 102 shows search message 3901 along with progress bar 3902. In alternative embodiments, other images may be displayed such as random clips from new films, or other advertisements or any other graphical image. Sound clips can also be played.

### FIG. 40

An example of results being displayed at step 3707 is shown in FIG. 40. Display means 102 shows instances of the received text string occurring within the selected asset. Images 4001 and 4002 are displayed having being extracted in accordance with procedures described with reference to FIGS. 12, 13 and 14. In this embodiment, if user input is received indicating interest in one of said images 4001 or 4002 then a clip is retrieved and displayed. This is further described with reference to FIGS. 41 and 42.

### FIG. 41

User input was received indicating interest in the second of the display results, by a user clicking on image 4002. As a result, procedures identified with reference to FIG. 21 are invoked in order to retrieve the clip of interest. Whilst this retrieval is occurring, a retrieval screen is displayed such as that shown in FIG. 41. Display means 102 shows a retrieval message 4101 along with a progress bar 4102.

### FIG. 42

Once a clip has been retrieved, it is displayed on display means 102, as illustrated in FIG. 42. In this embodiment the display of the clip is relatively small, in alternative embodiments it occupies the full screen. In particular, smaller versions may be advantageous in terms of requiring less bandwidth, a slower network connection, and also may reduce issues relating to copyright in the assets, or enable rights in the assets to be bought for a lower price.

Hence as a result of the “What's new?” operation, a film is selected, a text string is received defining audio content of interest, a database is searched to identify instances of the received text string and images taken from the respective video asset representing each instance are displayed. As a result of user indication of interest in one of said instances, a clip is shown. In the present embodiment, when any clip is shown the audio of the clip is played through speakers 107 and 108. In alternative embodiments headphones are provided as an alternative to speakers. In alternative embodiments, and dependent upon the location of station 101, clips may be shown without sound, possibly having the dialog expressed via subtitles.

1. A method of identifying video assets with reference to spoken audio content, comprising the steps of:
receiving a text string to define the audio content of interest;
searching a database to identify instances of said received text string; and
displaying an image taken from the respective video asset which contains each of said instances.

2. A method according to claim 1, wherein said video assets are films (movies).

3. A method according to claim 1, wherein said text string is received as input from a user.

4. A method according to claim 1, wherein said database is populated with data extracted from subtitles.

5. A method according to claim 1, wherein further input is received from a user indicating a preference for searching a subset of said database, and said searching step is adapted accordingly.

6. A method according to claim 1, wherein said database stores text strings defining audio content associated with timing information indicating the time at which said audio content is spoken in said asset.

7. A method according to claim 6, wherein said timing information is used to locate said image from said respective video asset such that said image is representative of approximately the time in said asset when said audio content of interest is spoken.

8. A method according to claim 1, wherein said image is selected from a set of images that have been extracted and stored for said respective video asset.

9. A method according to claim 8, wherein at least a portion of said video assets are stored remotely.

10. A method according to claim 1, wherein said image taken from said respective video asset is an image from the title sequence of said respective video asset.

11. A method according to claim 1, comprising the further steps of
receiving input from a user selecting one of said respective video assets for viewing;
transmitting a request to a remote server for a clip; and
displaying said clip of said selected asset to said user.

12. A method according to claim 1, further comprising the steps of
performing analysis on said instances of said received text string; and
providing statistics relating to said instances of said received text string to said user.

13. A computer-readable medium having computer-readable instructions executable by a computer such that, when executing said instructions, a computer will perform the steps of:
receiving a text string to define audio content of interest;
searching a database to identify instances of said received text string; and
displaying an image taken from the respective video asset which contains each of said instances.

14. A computer-readable medium having computer-readable instructions executable by a computer according to claim 13, wherein said video assets are films (movies).

15. A computer-readable medium having computer-readable instructions executable by a computer according to claim 13, wherein said text string is received as input from a user.

16. A computer-readable medium having computer-readable instructions executable by a computer according to claim 13, wherein said database is populated with data extracted from subtitles.

17. A computer-readable medium having computer-readable instructions executable by a computer according to claim 13, wherein said image is selected from a set of images that have been extracted and stored for said respective video asset.

18. A computer-readable medium having computer-readable instructions executable by a computer according to claim 17, wherein said video assets are not stored locally in their entirety.

19. A computer-readable medium having computer-readable instructions executable by a computer according to claim 13, further comprising the steps of:
receiving input from a user selecting one of said respective video assets for viewing;
transmitting a request to a remote server for a clip; and
displaying said clip of said selected asset to said user.

20. A computer-readable medium having computer-readable instructions executable by a computer according to claim 13, further comprising the steps of:
performing analysis on said instances of said received text string; and
providing statistics relating to said instances of said received text string to said user.
